(19) United States
(12) Patent Application Publication
(10) Pub. No.: US 2010/0238367 A1
(43) Pub. Date: Sep. 23, 2010

(54) LIGHT OUTPUT ARRANGEMENT AND DISPLAY

(76) Inventors: David James Montgomery, Oxford (GB); Sumanta Talukdar, Oxford (GB)

Correspondence Address: BIRCH STEWART KOLASCH & BIRCH, PO BOX 747, FALLS CHURCH, VA, 22040-0747, US

(21) Appl. No.: 12/600,192

(22) PCT Filed: Sep. 5, 2008
(86) PCT No.: PCT/JP2008/066479

§ 371 Date: Nov. 13, 2009

(30) Foreign Application Priority Data
Oct. 1, 2007 (GB) 0719040.8

(51) Int. Cl. G02F 1/13357; F21V 8/00; G02B 27/22

(52) U.S. Cl. 349/15; 362/551; 349/62; 359/475; 359/463

(57) ABSTRACT

A light output arrangement is provided and may be used as a backlight for a display. The arrangement comprises a bendable light-outputting layer (51), for example, comprising a light-guide, and a bendable light-directing layer (50), for example, comprising a lens array. The layers (50, 51) are fixed together so as to prevent relative lateral movement at the mid-points but otherwise are constrained to bend in conformance with each other. The light-directing layer comprises a plurality of structures, such as lenses (81), which cooperate with, for example, light extraction features (80) in the light guide (51) so as to direct light output from the light-directing layer (50) in substantially the same direction (82, 83) irrespective of bending of the layers (50, 51).

### TECHNICAL FIELD

The present invention relates to a light output arrangement, for example for use as a backlight for an at least partially transmissive spatial light modulator. The present invention also relates to a display including such a backlight and to a multiple view display.

### BACKGROUND ART

WO 2006/137623 (Fawoo) describes a flexible light-guide made from a soft synthetic resin material that allows the light-guide to be flexible. A plurality of LED light sources at one edge and V grooves on one surface of the resin means that light is guided and extracted from the light-guide. Applications include advertisement, illumination lighting and decoration.

WO 2006/004775 (National Semiconductor) describes a flexible touch screen light-guide made up of a coherent fiber bundle in the shape of a flat slab. Pressure from a finger or stylus brings the fibers into contact thus forming a reflective area that can be optically measured.

US 2007/0014097 (Hong Jin Park) describes a flat light-guide that is flexible in certain areas. The application is in mobile phone key-pads. Side illumination of the light-guide and extraction features in the flexible area allow light to leave the light-guide to illuminate the number on the key-pad. This allows soft key pressing and the extraction features can be patterned in the shape of a number.

US 2007/0147067 (Industrial Technology Research Institute, Taiwan.) describes a flexible backlight arrangement that involves a number of sections that are flexible between each segment. Each segment incorporates a light source and curved reflector with a lens arrangement. Each segment is identical and does not alter on bending. Applications include large area flexible display illumination.

U.S. Pat. No. 5,940,215 (Ericsson) describes a flexible light-guide made from a flexible transparent film substrate with high resolution complex patterns printed on the light-guide surface. This pattern acts as a strong diffuser, giving a near isotropic distribution of light emitted from the light-guide.

There is increasing interest in curved displays for numerous applications, in particular mobile displays, notebooks and automotive panels. The reasons for this development are typically related to style, which is an important commercial consideration, but also for space saving.

There is, in parallel with this development, curved backlight technology to fit the displays. This is mainly driven by the need for a reduction in size. A curved display with a flat backlight may take up more space than an equivalent un-styled flat display system.

The majority of this prior art concerns a fixed curve, in which the curve is known and the display and backlight are designed only for this curve.

However, with increasing interest in fixed curve technology, the usefulness of flexible type displays and, in particular, backlights becomes clear. Flexible in this instance means that the system can be bent to almost any shape, in one or two dimensions, and will still operate with the same properties. In the first instance, the usefulness of a flexible backlight allows fixed curves and styles to be manufactured without systematic redesign of each backlight shape and the fact that a single manufacturing process can be used for any design. This is especially important in a high volume high turnover market such as for mobile phones.

In addition, flexible backlights have tolerance to impact damage that is desirable in manufacturing.

Full flexibility also allows specific devices such as fold-out or roll-out type display systems and e-paper type systems.

Fully flexible displays based on OLED or related technology have so far failed to have an impact on the market mainly because of lifetime and brightness issues.

Liquid crystal (LC) is a well-developed and well-understood display technology and is the primary flat panel display technology that exists currently. A Flexible LC display (LCD) panel would be a preferable display solution due to its high quality and lifetime. Such panels do now exist. However, there is no flexible lighting technology for the LCD that can maintain the brightness, viewing freedom and uniformity similar to a flat LCD for such a flexible LC display.

FIG. 1 of the accompanying drawings illustrates a typical SLM display, 14, of known type. This type of SLM display is common in, for example, such devices as mobile phones, notebooks and automotive displays. The display comprises an LC display, 1, with front, 2, and rear, 4, polarisers that constitute the LC display panel. The display also comprises an LC SLM 3 and a backlight unit, 13. This comprises illumination devices (e.g. light emitting diodes, LEDs), 12, a light-guide, 9, a back reflector, 11, an upper, 5, and a lower, 8, diffuser and an upper, 6, and lower, 7, backlight enhancement film (BEF). The light is coupled out of the lightguide by extraction features, 10. There may also be other films.

FIG. 2a shows the backlight of FIG. 1 curved, 20. The vertical scale is exaggerated in this Figure. The display is curved about a common centre of curvature, 22, and the display subtends an angle, 21, at the centre of curvature. The curvature here is assumed to be a radius of curvature that is significantly smaller that the viewing distance of the display. This is the simplest type of curved backlight but the performance of this backlight differs from a flat backlight with regard to central brightness, apparent uniformity across the backlight and viewing freedom central to the display.

For curvatures of panel down to a 60° or so subtended angle (radius of curvature approximately 50 mm for a 2.4″ LCD) and for some higher angles, the amount of light lost from the light-guide due to the bend and not the extraction features is dependent on the ratio of light-guide thickness, 24, to radius of curvature at the lightguide, 23. For such backlights, this is typically insignificant.

The extraction features, 26, in FIG. 2c and BEF prismatic structures, 25, in FIG. 2b, are typically less than 0.1 mm in size. The angle subtended at the centre of curvature, 21a and 21b, is then typically less than 0.1°. Thus the effect of the curve is also insignificant to the optical performance of these features. Thus the extraction directions and collimation performance of the BEF locally is largely unchanged.

Considering a flat backlight illustrated in FIG. 3a, the viewer of the display, 31a, sees the display, 14, in such a way that the subtended angle from the viewer to a point on the display, 32a and 32b, to the display surface normal, 33, does not change significantly at any point on the display. The brightness emitted as a function of angle, shown approximately in 34, is the same relative to 33 at all points on the display. Thus on the left hand side of the display, the brightness at the viewer, 35a, determined by the angle 32a is not very different from the brightness 35b, determined by the angle 32b, because the angles 32a and 32b are not very different. In FIG. 3b, if the viewer, 31b, moves off axis, the relationships between the new angles 32c and 32d is still that they are very similar. Thus, the brightness at different points, 35c and 35d, are still very similar. Hence the display remains uniform.

To maintain brightness, each point on the display need only collimate the light along the display normal, 33. To maintain uniformity, the brightness of light emitted from each point on the display should not change significantly between different points. To maintain viewing freedom, the light emitted at each direction from each point on the display also does not need to be different. Thus uniformity (though not necessarily brightness) is maintained at different viewing angles, hence a good viewing freedom.

Thus for a flat backlight, the BEF films, 6 and 7, collimate along the display normal, 33, and the distribution of extraction features, 10, ensures uniformity. Identical BEF and extraction feature optical shape at different points ensures viewing freedom.

For the case of a fixed curve backlight, 20, illustrated in FIG. 4a, where the curve radius is much shorter than the viewing distance of the viewer, these assumptions for a flat backlight above are no longer true.

For an on-axis viewer 41a as shown in FIG. 4a, the angles 42a and 42b subtended by the direction to the viewer 41a and the local display normal 43 at the edges of the display have the same magnitude. Because of the curvature of the display, the local display normal 43 varies in direction across the display so that the angle of the viewer to the local normal also varies.

The brightness graph in FIG. 4a shows that this particular display provides uniform brightness, such as 45a and 45b, across the display for an on-axis viewer. However, as shown in FIG. 4b, an off-axis viewer, 41b, sees different brightnesses, 45c and 45d at the edges of the display from markedly different parts of the brightness graph 34. Now that the angles 42c and 42d of the off-axis viewer to the local normals are very different, the gradient of the brightness graph is very different at these points. Thus the motion off axis will cause 45c and 45d to take different values and hence the apparent uniformity and viewing freedom will reduce markedly.

It is possible (in the prior art) to make the brightness from each direction at each point the same to maintain viewing freedom. This is done by applying a strong diffuser. However, the central brightness is reduced to a great extent and this is not acceptable in most applications.

It is also possible, for a fixed curve, to alter the shape of the extraction features as disclosed in British Patent Application No. 2443849. This can be done to correct the viewing freedom and brightness for a particular curve shape.

There is no system in the prior art that can maintain central brightness, viewing freedom and uniformity for any arbitrary curve shape, dependent only on the shape that it is physically forced into, i.e. a fully flexible backlight.

### DISCLOSURE OF THE INVENTION

According to a first aspect of the invention, there is provided a light output arrangement comprising a bendable light-outputting layer and a bendable light-directing layer constrained to bend in conformance with the light-outputting layer, a first point of the light-outputting layer and a first point of the light-directing layer being fixed relative to each other so as to prevent relative lateral movement between the first points, the light-directing layer comprising a plurality of structures arranged to direct light from the light-outputting layer passing through the light-directing layer in a substantially same direction relative to the first points irrespective of bending of the layers.

The layers may be constrained to have a substantially constant spacing irrespective of bending thereof.

At least one second point of the light-outputting layer and at least one second point of the light-directing layer may be fixed relative to each other, after bending of the layers, so as to prevent lateral movement between the layers.

The first points may be at or adjacent the middles of the layers.

The light-outputting layer may comprise a light guide. The light guide may comprise a plurality of light extraction features. Each light extraction feature may be arranged to direct light out of the light guide in a direction substantially parallel to a local normal. Each of the extraction features may comprise a concave feature in a first surface of the light guide facing a second output surface of the light guide. Each of the concave features may comprise at least one inclined surface for reflecting light travelling in the light guide towards the output surface.

Each of the structures may cooperate with a set of the features for directing light in substantially the same direction, where each set comprises at least one feature.

At least some of the extraction features may be arcuate in plan.

At least one of the surfaces of the light-outputting layer and the light-directing layer may be provided with a plurality of linear light-diffusing features.

The structures may be arranged to direct light substantially parallel to the normal to the first point of the light-directing layer. As an alternative, the structures may be arranged to direct light in at least two different directions with respect to the normal to the first point of the light-directing layer.

Each of the structures may comprise a lens. Each lens may be a converging lens. The lenses may have a focal surface at the light-outputting layer. The focal surface may be at or adjacent the light extraction features. Each of at least some of the lenses may be laterally asymmetric so as to be of reduced width.

The lenses may be arranged as a one dimensional array of substantially cylindrically converging lenses. As an alternative, the lenses may be arranged as a two dimensional array. The lenses may be substantially spherically converging.

The arrangement may comprise an at least partially transmissive spatial light modulator disposed between the light-outputting layer and the light-directing layer. As an alternative, the light-outputting layer may be adjacent the light-directing layer. Each structure may comprise a deformable material having a first surface attached to a bendable sheet to form the light-directing layer, a facing second surface attached to the light-outputting layer and an inclined third surface for reflecting light, which has passed through the second surface of the material, through the first surface of the material. The material may be resilient. The material may have a refractive index substantially equal to the refractive indices of the light-outputting layer and the sheet. Each structure may have a trapezoidal cross-section. As an alternative, each structure may be part-spherical.

The arrangement may comprise a backlight for an at least partially transmissive spatial light modulator.

According to a second aspect of the invention, there is provided a display comprising: a backlight comprising a bendable light-outputting layer and a bendable light-directing layer constrained to bend in conformance with the light-outputting layer, a first point of the light-outputting layer and a first point of the light-directing layer being fixed relative to each other so as to prevent relative lateral movement between the first points, the light-directing layer comprising a plurality of structures arranged to direct light from the light-outputting layer passing through the light-directing layer in a substantially same direction relative to the first points irrespective of bending of the layers; and an at least partially transmissive spatial light modulator.

According to a third aspect of the invention, there is provided a display comprising: a light output arrangement comprising a bendable light-outputting layer and a bendable light-directing layer constrained to bend in conformance with the light-outputting layer, a first point of the light-outputting layer and a first point of the light-directing layer being fixed relative to each other so as to prevent relative lateral movement between the first points, the light-directing layer comprising a plurality of structures arranged to direct light from the light-outputting layer passing through the light-directing layer in a substantially same direction relative to the first points irrespective of bending of the layers; and an at least partially transmissive spatial light modulator disposed between the light-outputting layer and the light-directing layer.

The modulator may comprise a liquid crystal device.

According to a fourth aspect of the invention, there is provided a multiple view display comprising an arrangement according to the first aspect of the invention, in which the light-directing layer comprises a parallax optic, the structures comprise parallax elements and the light outputting layer comprises a display device for displaying a plurality of spatially multiplexed images.

The display device may be a liquid crystal device.

The parallax optic may comprise a lens sheet and the parallax elements may comprise lenses. As an alternative, the parallax optic may comprise a parallax barrier and the parallax elements may comprise apertures.

The display may comprise a backlight comprising an arrangement according to the first aspect of the invention.

The expression “constrained to bend in conformance” as used herein means, when referring to two or more layers, that, after bending, the layers have substantially the same shape subject to possible small differences, for example in curvature, such that the layers continue to fit together snugly or maintain a substantially fixed separation.

It is thus possible to provide an arrangement which may be used in backlighting technology to maintain central brightness along a preferred configurable direction, uniformity and viewing freedom even when bent to an arbitrary radius of curvature. Backlights may be provided that are capable of being bent in two directions or about an arbitrary angle including complex and facetted curve shapes.

A fully flexible system may be provided where the user can bend the display and backlight himself. The brightness, viewing freedom and uniformity are comparable to an existing flat backlighting system. Such a system does not exist in the prior art.

It is possible to manufacture different fixed curve geometries from a single production line and backlight design. In addition, foldable and related e-paper display applications with flexible LCDs become possible.

It is also possible to provide for a configurable direction of primary brightness enhancement and also for more than one direction of brightness enhancement, such as is required for flat panel multiple view and stereoscopic display systems.

It is also possible to allow for correction for angular dependent contrast ratio in existing flexible LC display panels.

It is also possible to allow for the correction for parallax based display systems related to parallax barrier and lenticular barrier stereoscopic, autostereoscopic and multiple independent view displays. Such displays can be made flexible while maintaining the parallax relationship between panel and optical element so that the viewing windows remain substantially in the same place at all bends. Such displays can be made with flexible backlights as described earlier.

The foregoing and other objectives, features, and advantages of the invention will be more readily understood upon consideration of the following detailed description of the invention, taken in conjunction with the accompanying drawings.

### BRIEF DESCRIPTION OF THE DRAWINGS

FIG. 1 shows a known display module consisting of a LCD and backlight unit;

FIG. 2a shows a known curved display arrangement consisting of a LCD and backlight unit;

FIG. 2b shows a known curved display arrangement showing a detail of the BEF prism structures;

FIG. 2c shows a known curved display arrangement showing a detail of the extraction features;

FIG. 3a is a diagram illustrating the range of angles subtended at the display by the on-axis viewer to the display normal for a flat display;

FIG. 3b is a diagram illustrating the range of angles subtended at the display by the off-axis viewer to the display normal for a flat display;

FIG. 4a is a diagram illustrating the range of angles subtended at the display by the on-axis viewer to the display normal for a curved display;

FIG. 4b is a diagram illustrating the range of angles subtended at the display by the off-axis viewer to the display normal for a curved display;

FIG. 5 is a diagram illustrating a general embodiment of this invention;

FIG. 6 is a diagram illustrating a method of alignment for the embodiment of FIG. 5;

FIG. 7a is a diagram illustrating the first embodiment of this invention;

FIG. 7b is a diagram illustrating the definitions of direction for the first embodiment;

FIG. 8 is a diagram illustrating a detail of the first embodiment of this invention;

FIG. 9a is a diagram illustrating one aspect the lens sheet of the first embodiment;

FIG. 9b is a diagram illustrating another aspect the lens sheet of the first embodiment;

FIG. 10a is a diagram illustrating possible extraction features for the first embodiment;

FIG. 10b is a diagram illustrating the direction of possible extraction features in the first embodiment;

FIG. 10c is a diagram illustrating the operation of the extraction features for the first embodiment;

FIG. 11 is a diagram illustrating the distribution of extraction features for the first embodiment;

FIG. 12a is a diagram illustrating one aspect of the alignment for the first embodiment;

FIG. 12b is a diagram illustrating another aspect of the alignment for the first embodiment;

FIG. 13 is a diagram illustrating a new lens arrangement for the first embodiment;

FIG. 14a is a diagram illustrating the bend radii for the first embodiment;

FIG. 14b is a diagram illustrating the relative feature position in the first embodiment;

FIG. 15 is a diagram illustrating the convex operation of the first embodiment;

FIG. 16a is a diagram illustrating the stripe extraction features of the second embodiment;

FIG. 16b is a diagram illustrating the broken stripe extraction features of the second embodiment;

FIG. 16c is a diagram illustrating the different sized extraction features of the second embodiment;

FIG. 17a is a diagram illustrating the stripe extraction features of the third embodiment;

FIG. 17b is a diagram illustrating the lens sheet of the third embodiment;

FIG. 18 is a diagram illustrating the minimum diameter of the lens in the fourth embodiment;

FIG. 19a is a diagram illustrating one aspect of the arrangement in the fourth embodiment;

FIG. 19b is a diagram illustrating another aspect of the arrangement in the fourth embodiment;

FIG. 20a is a diagram illustrating the fifth embodiment;

FIG. 20b is a diagram illustrating the lens sheet in the fifth embodiment;

FIG. 20c is a diagram illustrating the arrangement of extraction features in the fifth embodiment;

FIG. 20d is a diagram illustrating the alignment of extraction features and lenses in the fifth embodiment;

FIG. 20e is a diagram illustrating two-dimensional bending of a display;

FIG. 21a is a diagram illustrating the sixth embodiment;

FIG. 21b is a diagram illustrating the trapezoid extraction features of the sixth embodiment;

FIG. 21c is a diagram illustrating the spheroid extraction features of the sixth embodiment;

FIG. 22 is a diagram illustrating the spacer balls of the sixth embodiment;

FIG. 23 is a diagram illustrating the operation of the sixth embodiment;

FIG. 24a is a diagram illustrating one aspect of the seventh embodiment;

FIG. 24b is a diagram illustrating another aspect of the seventh embodiment;

FIG. 25 is a diagram illustrating the eighth embodiment;

FIG. 26 is a diagram illustrating the distribution of the ninth embodiment;

FIG. 27 is a diagram illustrating the operation of the tenth embodiment;

FIG. 28 is a diagram illustrating the operation of the eleventh embodiment;

FIG. 29 is a diagram illustrating the operation of the twelfth embodiment;

FIG. 30a is a diagram illustrating a modified lightguide;

FIG. 30b illustrates a detail of the lightguide of FIG. 30a to an enlarged scale;

FIG. 31 is a diagrammatic plan view of another type of lightguide;

FIG. 32a is diagrammatic cross-sectional view of part of a display constituting another embodiment; and

FIGS. 32b, 32c and 33 are diagrammatic cross-sectional views of lens arrays for use in the display of FIG. 32a.

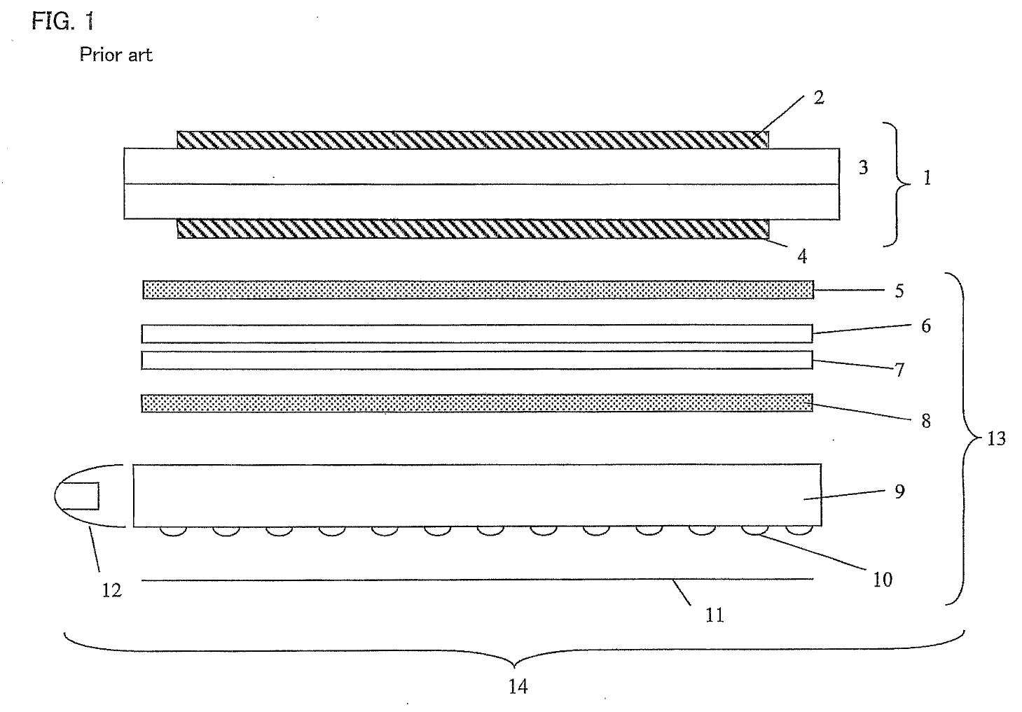

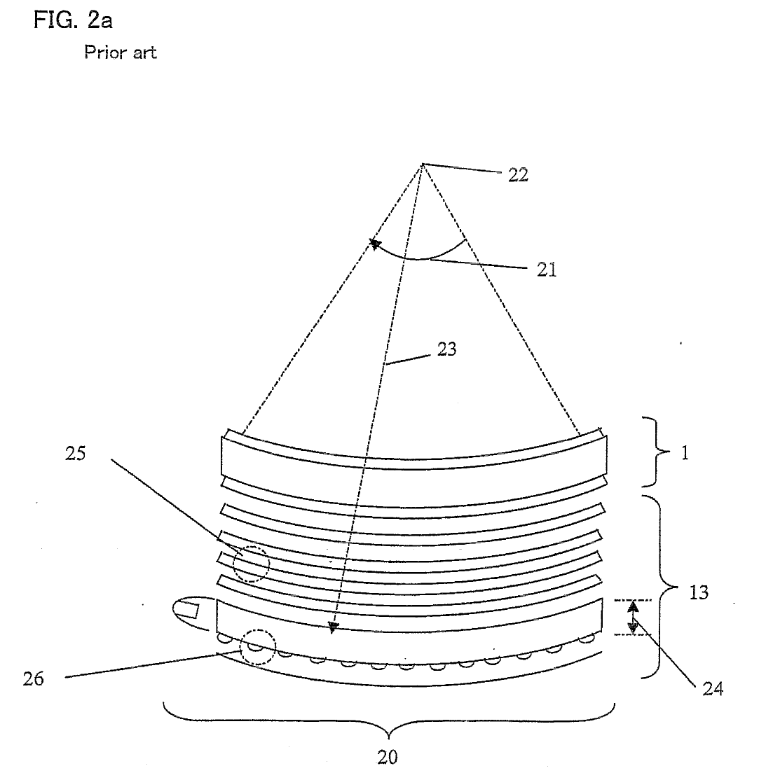

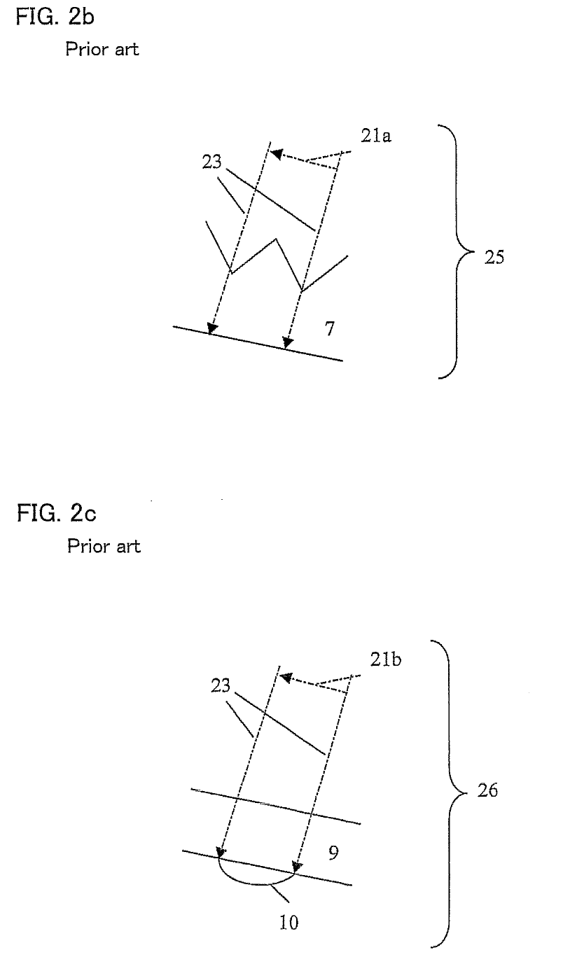

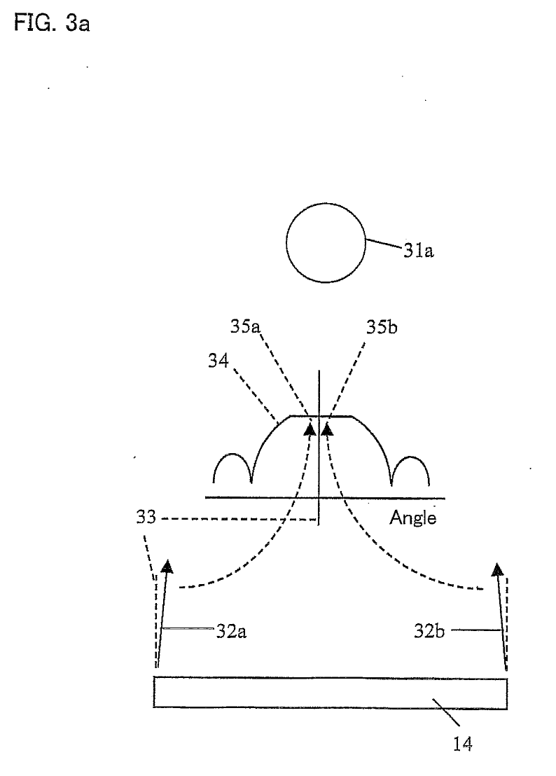

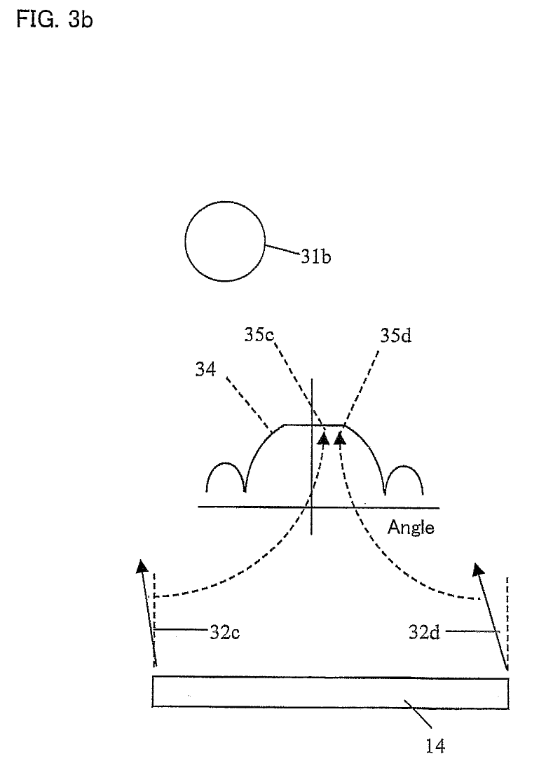

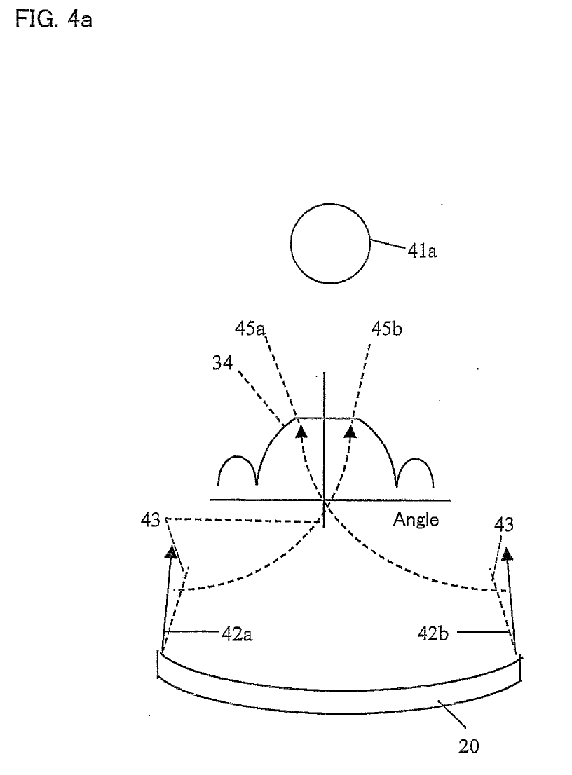

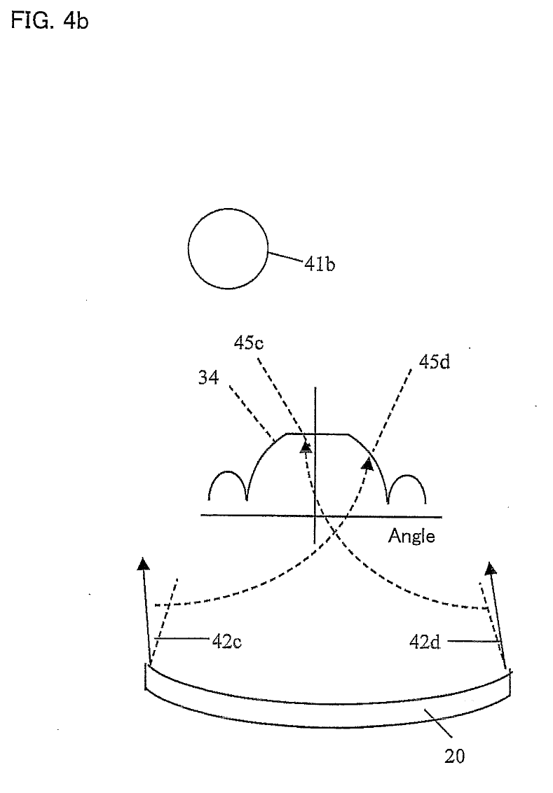

### BEST MODE FOR CARRYING OUT THE INVENTION

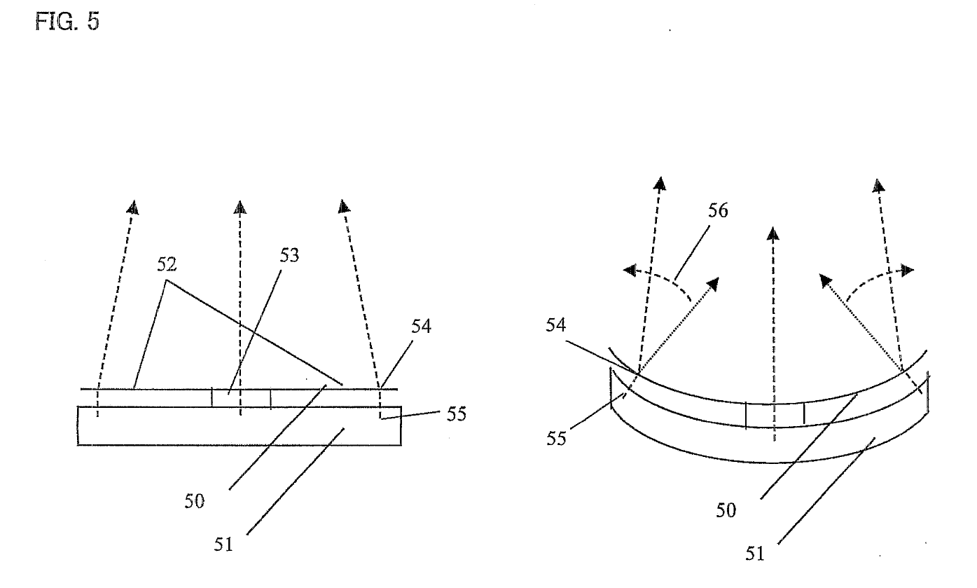

FIG. 5 shows a backlight comprising at least two parallel flexible layers, 50 and 51, that can move relative to each other in at least one part, 52, and are fixed relative to each other at another part, 53. The layers 50 and 51 have optical directing components, such as light-directing structures 54 and light extraction features 55, respectively, that are fixed to or integral with the layers, 54 and 55, or have flexible features fixed to both layers. In the following embodiments, the layer 50 constitutes a light-directing layer and the layer 51 constitutes a light-outputting layer.

The components are such that the relative movement (parallax) will change the angle at which the light leaves the top layer when the layers are bent, 56. The change in angle is such as to reduce any change on the display/backlight appearance to a remote observer when the display is bent. In the following embodiments, the light-directing layer comprises structures which direct light from the light outputting layer passing through the light-directing layer in a substantially same direction relative to fixed points of the layers irrespective of conformal bending of the layers. The layers may be constrained to have substantially constant spacing irrespective of bending.

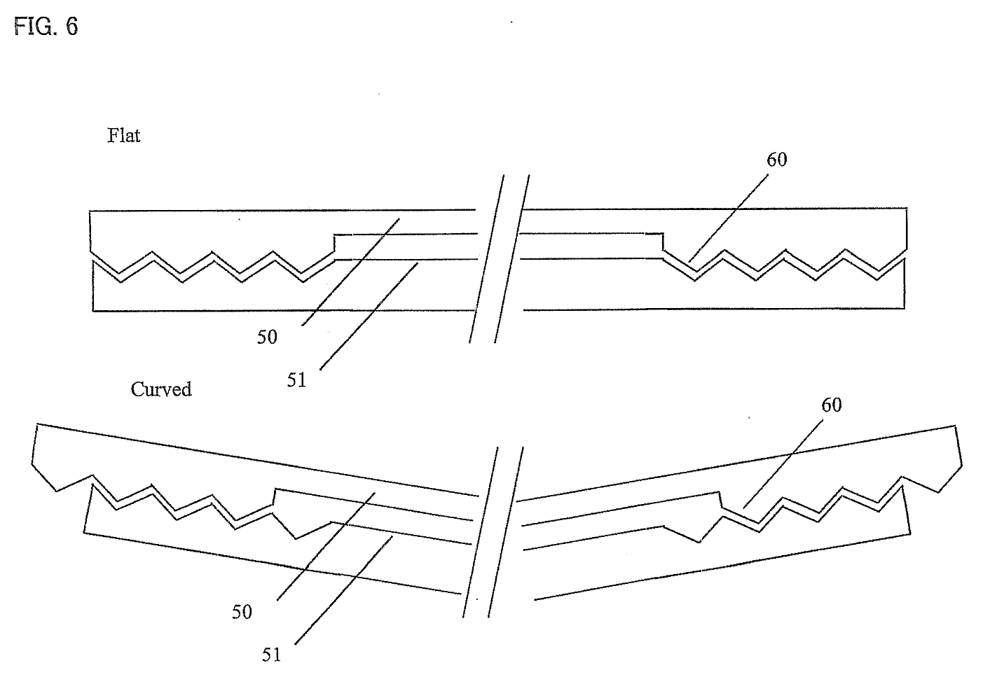

The fixed part may be a single area fixing (e.g. points at or adjacent the middles of the layers) and determines alignment and direction of best brightness. It can also be a self aligning set of teeth, 60, at multiple points that determine an alignment position (FIG. 6).

The observer then sees that, when the backlight is bent, there is a reduced change in brightness, viewing freedom and uniformity on the backlight and display system.

The backlight can be used as a fully flexible system and also as a single design that can be subsequently fixed during manufacture into a particular arrangement.

This backlight can be used for flat panel display illumination, such as behind an SLM based display (e.g. LCD). The LCD may even be arranged to form or provide the layer so, for example by forming lens structures on a rear polariser of the LCD. There is no size restriction to this application.

Such a backlight may also be used, in large sheets, for signage and general illumination, unrelated to flat panel displays, when used on its own or with other fixed image systems (coloured slides etc.).

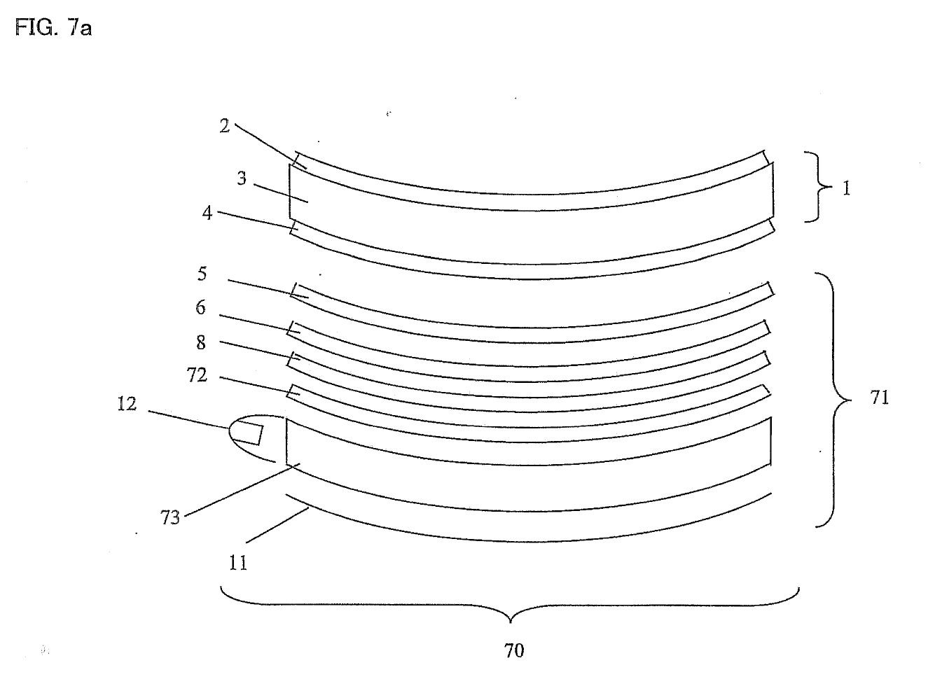

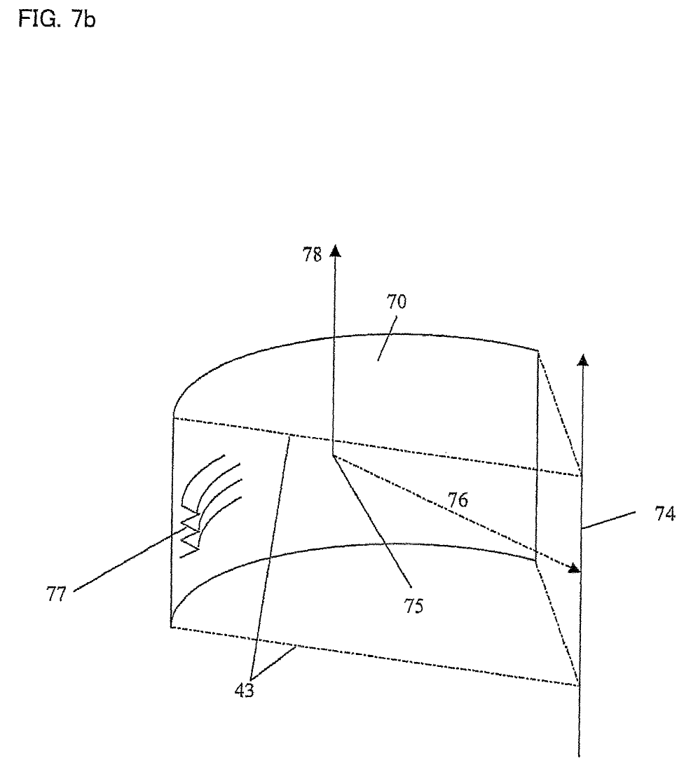

FIG. 7a illustrates an embodiment, in the form of a display, 70, comprising an SLM display panel, 1, and a backlight, 71, for use in one of the aforementioned applications. The backlight comprises a light-guide, 73, a reflector, 11, positioned under the light-guide, a light source positioned along one edge of the light-guide, 12, a lens array positioned above the light-guide, 72, a lower diffuser layer, 8, a BEF layer, 6, and an upper diffuser layer, 5, in that order.

There may be additional film layers or modifications to the light-guide that would normally be present in standard light guides, but they do not affect the operation of this embodiment.

The light source may be LEDs or fluorescent lamps of known types. They can be along the long or short parts of the lightguide.

The reflector, diffusers and BEF may also be of known types.

The bend direction is assumed to be one-dimensional (cylindrical) and can be along or perpendicular to the direction that light enters the lightguide from the source. The bend direction, 78, is defined as the direction on the lightguide parallel with the cylinder axis of symmetry, 74, and in the plane of the display, 70. These are illustrated in FIG. 7b.

The BEF layer 6 is placed so that the direction along the prisms, 77, is perpendicular to the bend direction, 78, as defined above.

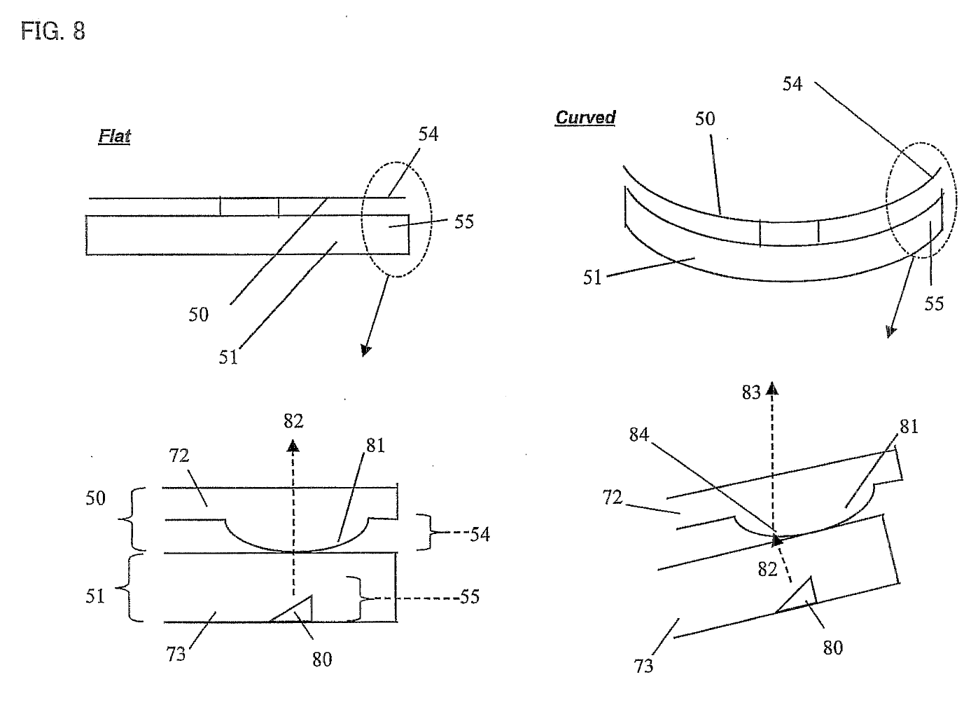

FIG. 8 shows a detail of FIGS. 7a and 7b and illustrates the operation of this embodiment and its relationship to the general embodiment. The first layer, 51, is the lightguide, with the extraction features, 80, acting as the optical directing components, 55. The second layer, 50, is the lens array, 72, consisting of converging lenses as the optical directing components, 54. The extraction features have inclined surfaces which reflect light vertically, 82, through the lens to the viewer. When the display is bent, the features direct light vertically, 82, but the parallax with the lens causes the light to hit the lens off-centre, 84, and so on bending corrects the light direction, 83, back towards the viewer. The following text will describe in more detail the operation of this embodiment.

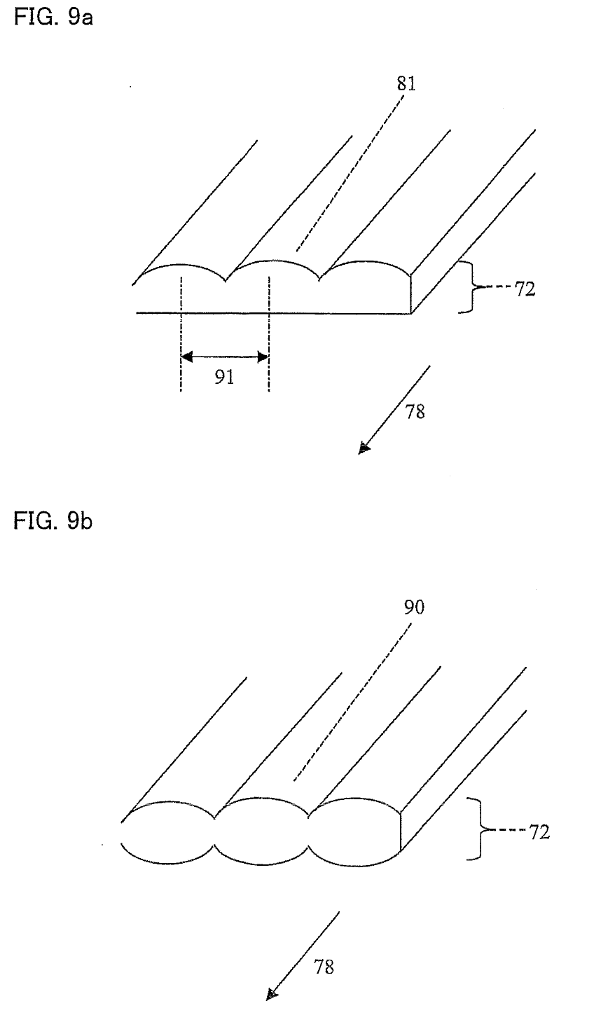

The lens array consists of a flexible sheet with long straight lenticular lenses (that may be aspheric) on one, 81, (FIG. 9a) or both, 90, (FIG. 9b) of the large faces of the lens array, 72. The direction of the lenticular lenses on the lightguide is in a direction parallel with the bend direction, 78. The lenses are identical and have a constant pitch, 91, and separation. The lenses 81 have foci disposed in a focal surface at the light guide 73 at or adjacent the extraction features 80.

The lightguide, 73, consists of a slab type flexible transparent material that guides light by total internal reflection along and across its length and breadth.

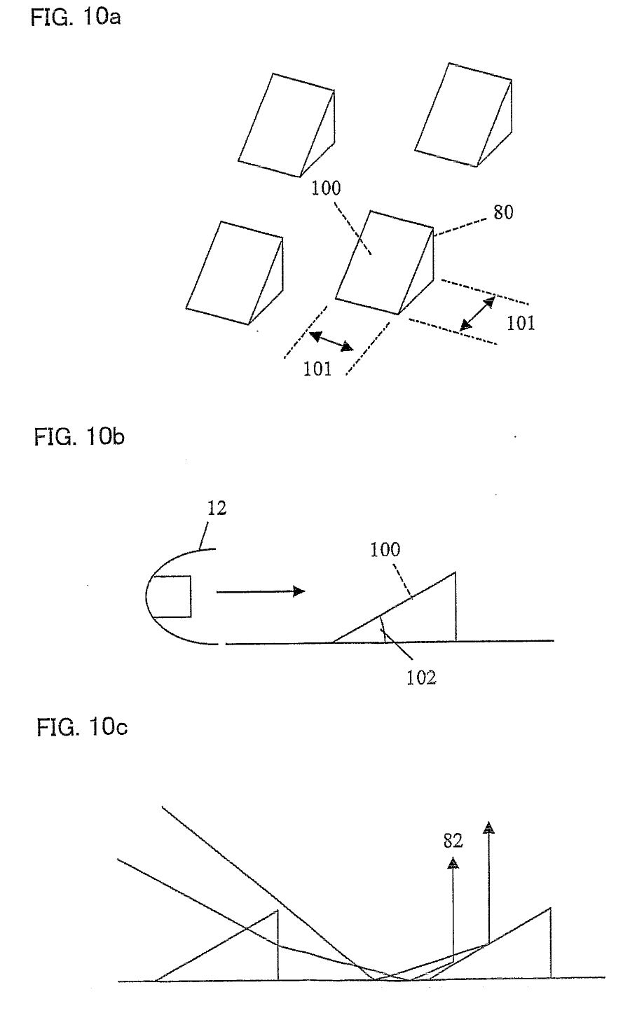

The light in the lightguide can be extracted from the lightguide, 73, by extraction features, 80, of a type illustrated in FIG. 10a. The length of one side, 101, can be in the range 20-100 mm, but this is not required, nor is it required that the sides be equal in size. These extraction features could take the shape of triangular wedges (FIG. 10b), with the slope side, 100, facing towards the light source, 12. The angle the slope makes with the base of the light guide, 102, can be in the range 45° to 51°, where then the extracted light will be emitted in a relatively narrow cone along the lightguide normal. FIG. 10c illustrates the operation of the extraction features to provide collimated light, 82.

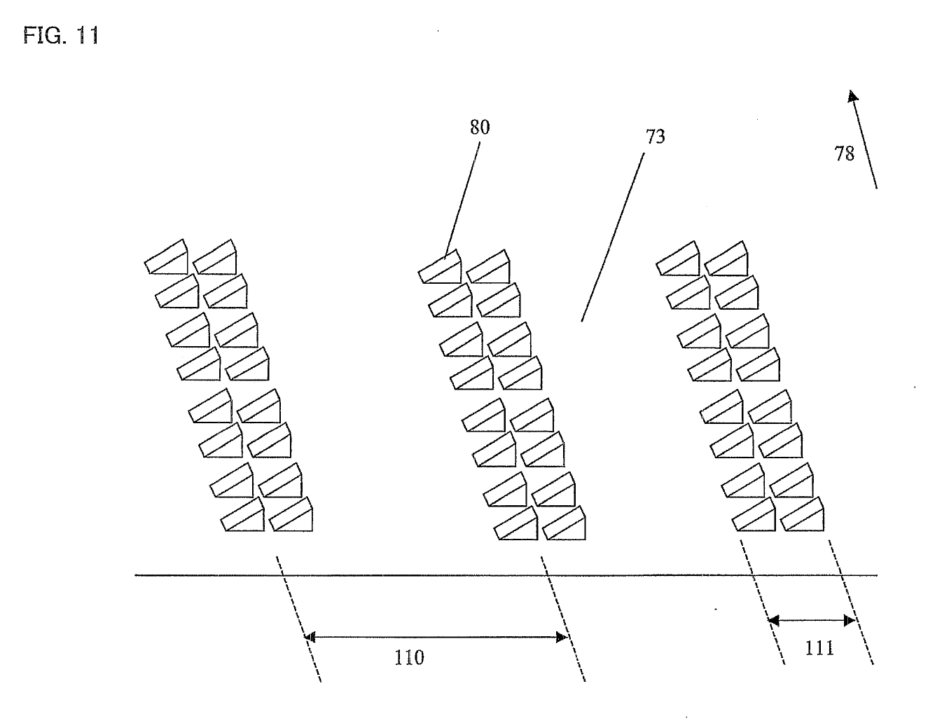

The extraction features are arranged in striped areas, illustrated in FIG. 11, with a pitch of these striped areas, 110, substantially uniform and substantially equal to the pitch of the lens sheet, 91. The stripes are parallel to the bend direction, 78, of the lightguide and lens array, 72. The width of each stripe, 111, is significantly less than the pitch, 110, and can be half of the pitch. This width is also substantially equal to other stripes across the panel.

The stripes are substantially identical to each other and the extraction features within each stripe may be substantially identical to each other. However it is also possible to provide extraction features whose slope angles vary within each stripe. Such an arrangement may be used to provide a wider light output cone in the same general direction so as to reduce visibility of the lens structure and hence improve the quality of displayed images.

It is possible that the stripe pattern can have a very slightly larger pitch than that of the lens sheet to correct for the finite viewing distance of the viewer.

The number of triangular wedges in each stripe is such that the amount of light from each stripe matches a required level of brightness across the stripe and can be equal across the length of the stripe. Each stripe also emits relative to each other according to a known brightness distribution, and this can be that each stripe emits an equal amount of light to every other.

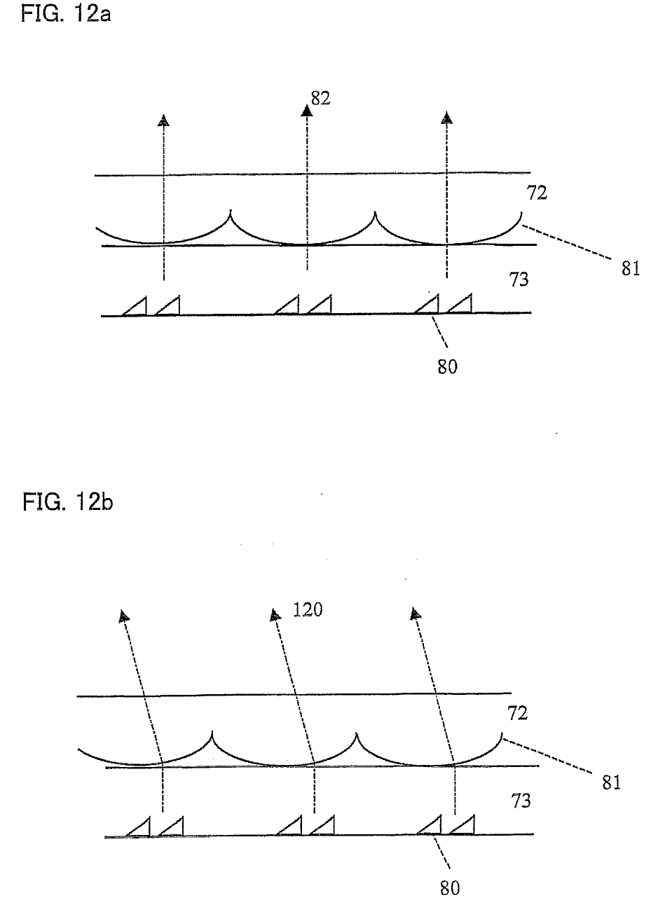

The backlight is assembled according to the description above and the lens sheet is aligned so that the centre of each lens is substantially above the centre of each stripe at the centre of the display, illustrated in FIG. 12a.

It is possible that the centre of the lens sheet at the centre of the display is offset from the centre of the stripe. This will create a high central brightness region that is not normal to the display and backlight, 120. This may be desirable in certain applications and is illustrated in FIG. 12b.

The lens sheet is fixed to the display along the centre line parallel to the bend direction, but the lens sheet is free to move relative to the lightguide at all other parts.

The fixing may be by glue, or mechanical fixings at the top and bottom of the display as described above.

The fixing may also be by sliding tooth arrangement at each side of the display (FIG. 6).

The individual lenses in the lens sheet can have a focal plane combined in one stripe substantially equal to the plane of the extraction features in the lightguide.

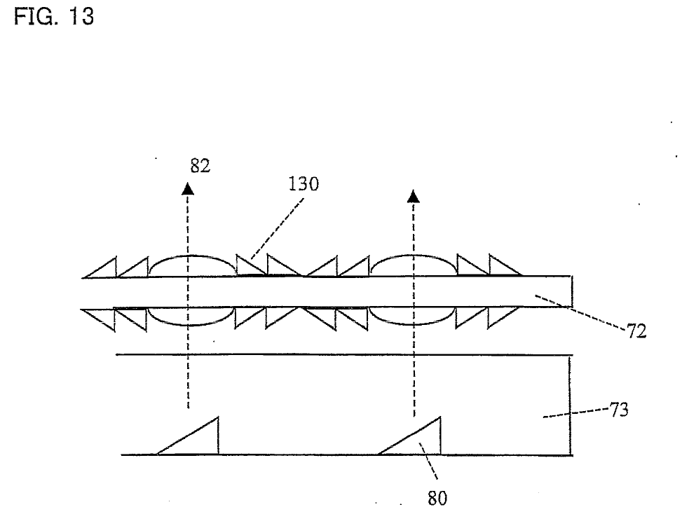

The lenses in the sheet can be Fresnel lens or micro-prism structures, 130, which may be thinner than full lens structures (FIG. 13). Other types of lens structure such as liquid crystal lenses could also be used.

When this backlight is bent, the central area of the backlight is fixed. The light direction through the lens defines the primary high brightness area, and in this case it is normal to the display at the central point.

On bending, assuming a concave bend relative to the viewer, the two layers bend relative to each other as is illustrated in FIG. 8. As the layers are flexible but are constrained to lie directly next to each other, they will find a shape where the two layers will have slightly different radii of curvature. As they are in general relatively incompressible layers, the length of each layer will remain substantially the same.

For a given point on the lightguide layer (e.g. centre of a stripe) and a given point on the lens layer (e.g. centre of the lens) that are normally directly above each other when the backlight is flat, we can determine the relative orientation after bending.

In FIG. 7b, there is defined a “normal axis”, 76, which exists normal to the centre of the display, 75, and to the cylindrical axis, 74. This normal axis can define the optimum viewing position of the viewer, assumed in this case, for simplicity, to be a long distance away and central to the display, but the corrections mentioned above will apply if the viewer is at a finite distance or offset from the centre and the argument below still applies.

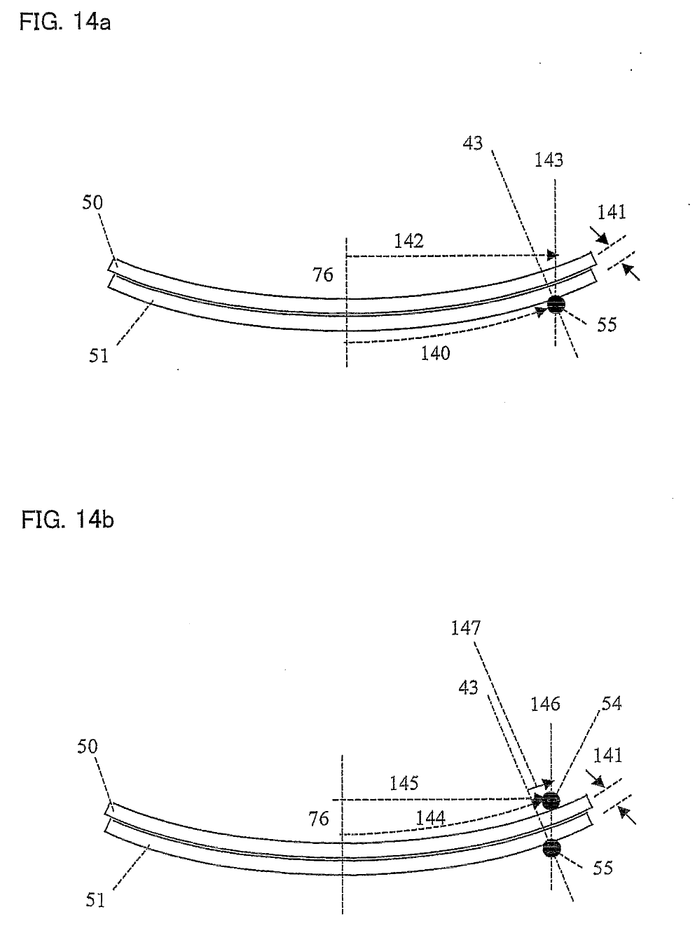

Considering FIG. 14a, the distance of a point on the first layer (lightguide) at which an optical directing component 55 is located, when the backlight is flat, from the normal axis, 76, is L. When the backlight is bent, the distance around the curve, 140, on the first layer is also L to that point. The horizontal distance, 142, from the normal axis, 76 to the point is shorter. If the radius of curvature (distance of the display to the cylindrical axis, 74, along the local normal, 43) is R, then the horizontal distance, 142, is given by:

$$R sin ( \frac{L}{R} ) \qquad ( Equation 1 )$$

from simple geometry, where the argument of the sine is in radians.

In FIG. 14b, the second layer (lens layer) will follow a slightly different radius of curvature, R-t, where t is a value depending on the thickness of the lightguide, 141, but also on the relative compressibility of the layers. This is because the second layer is slightly closer to the cylindrical axis 74 than the first sheet. The actual value of t is unimportant, however. An optical directing component 54 at a point is considered that is also the same distance L from the normal axis, 76, as the point on the first layer. When the backlight is flat, the two points lie along the same local normal line 143 (i.e. they are directly above each other). When the backlight is bent, the distance around the curve, 144, to the point at which the component 54 is located is also L. The normal distance from the normal axis, 145 of the point is then:

$$( R - t ) sin ( \frac{L}{R - t} ) \qquad ( Equation 2 )$$

For most angles, these two values of the normal distances 142 and 145 are not significantly different. Thus the relative orientation of the two points is such as the joining line between the two points, 146, is no longer parallel to the display normal, 43, at the point location, but is parallel to the normal axis, 76. Thus, locally at this point the lens is now offset from the local normal axis, 43, of the lightguide by an amount, 147, given by:

$$t tan ( \frac{L}{R} ) \qquad ( Equation 3 )$$

Thus locally at the two points, illustrated in FIG. 8, the triangular wedge emission from the lightguide, 82, is still along the local display normal, 43, but the lens position is now different. The light is then deflected by the shifted lens, 81, so that the direction after the lens deflection, 83, is substantially parallel to the normal axis, 76, i.e. substantially towards the brightness direction defined by the alignment in the centre, 75. Thus the viewer sees the brightness at this part of the lightguide as the same as the central area and the properties of the lightguide to be similar to that of the backlight in the flat configuration.

It is important that there is only one BEF in this case and it is orientated, 77, perpendicular to the bend axis, 78.

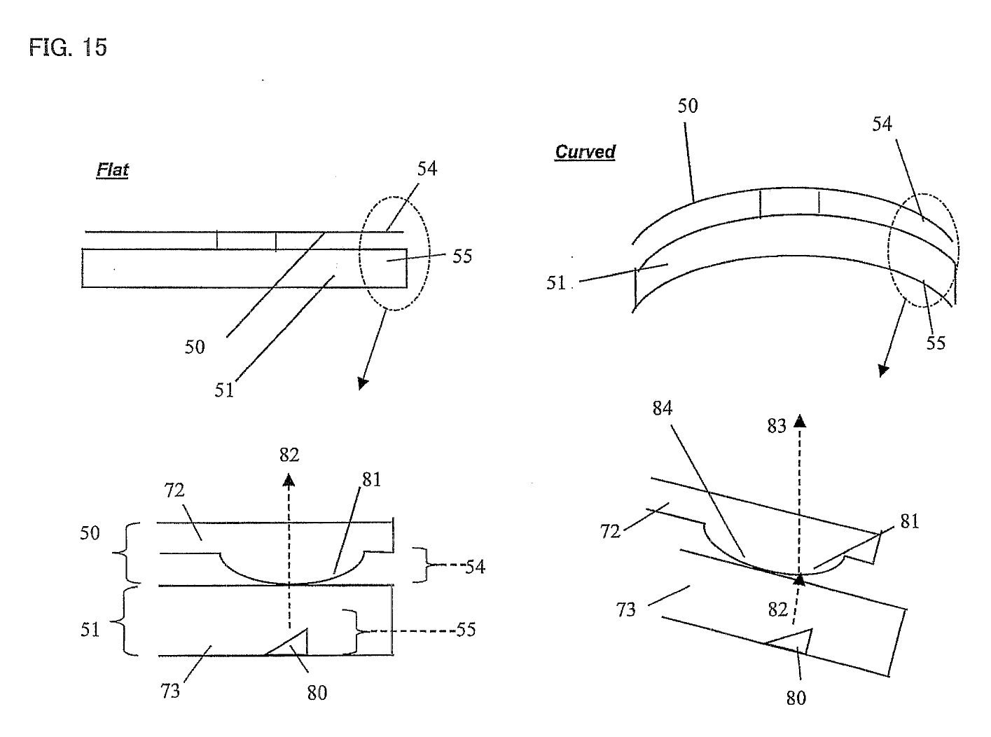

The operation of this design will be similar if the bend is convex as well as concave. The same arguments apply and this is shown in FIG. 15. No modification to the design need be made in this case.

It is preferred that the lens sheet and lightguide are made from the same material to ensure temperature and other environmental effects do not affect the operation of this embodiment.

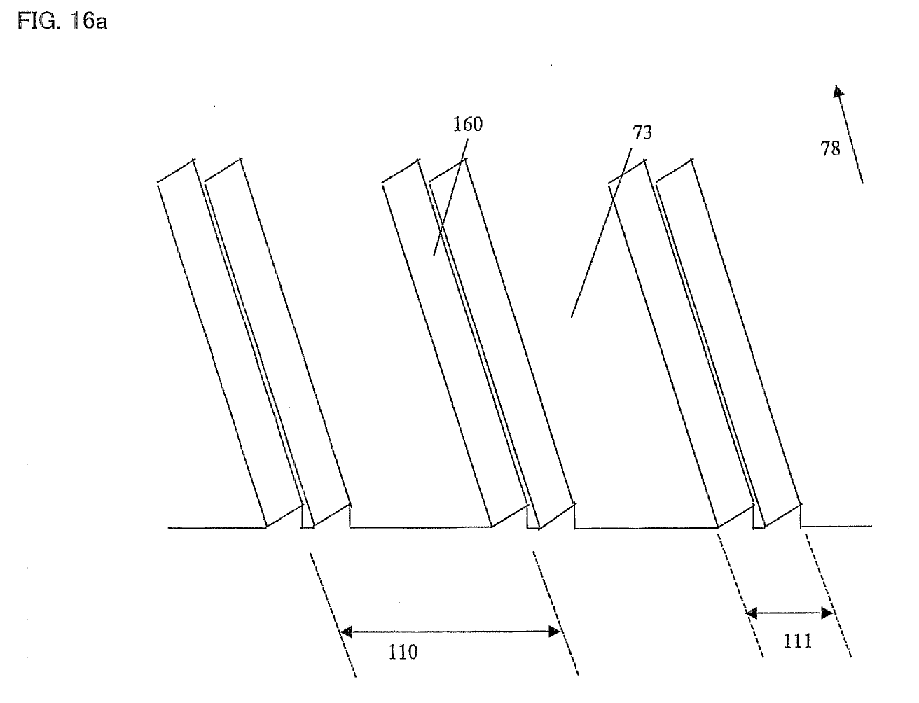

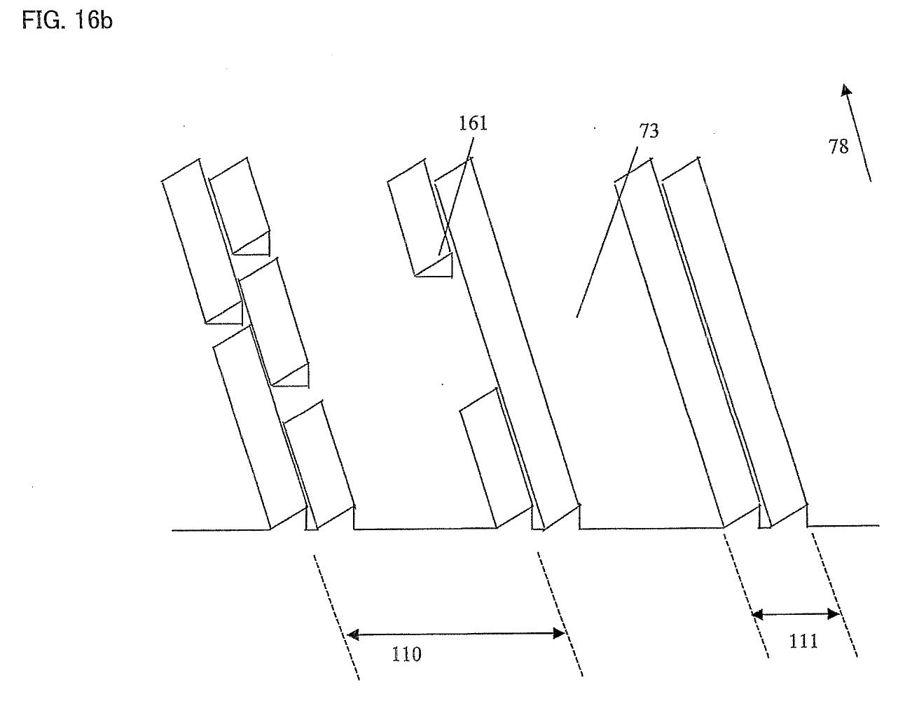

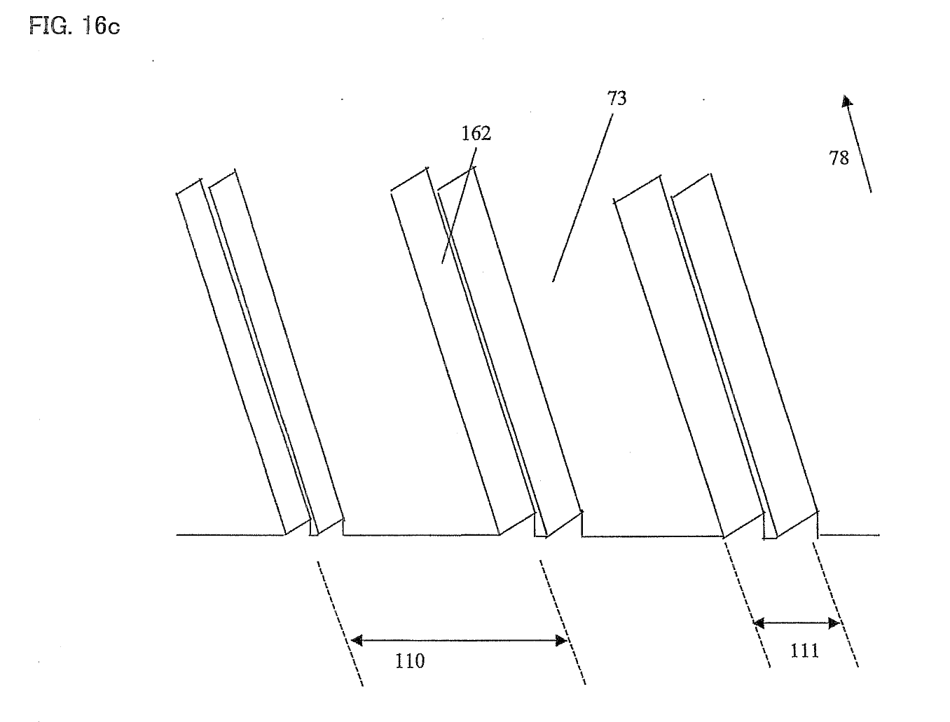

A second embodiment is shown in FIG. 16a and is similar to the first embodiment. Only the differences will be described here.

In this case, the extraction features are long prism structures, 160, that extend the whole length of the lightguide within one stripe. There may be more than one feature per stripe. These features still have an identical triangular cross section to the wedge features and are illustrated in FIG. 16a.

It order to maintain uniformity, it may be necessary to break the prism structures up into long lengths rather than all the way across the lightguide, 161. This is illustrated in FIG. 16b. It is also possible to change the cross sectional size of each feature instead to maintain uniformity, 162. However, it is important to maintain the same slope (FIG. 16c).

Long prism type structures may be easier to manufacture than individual wedge type structures.

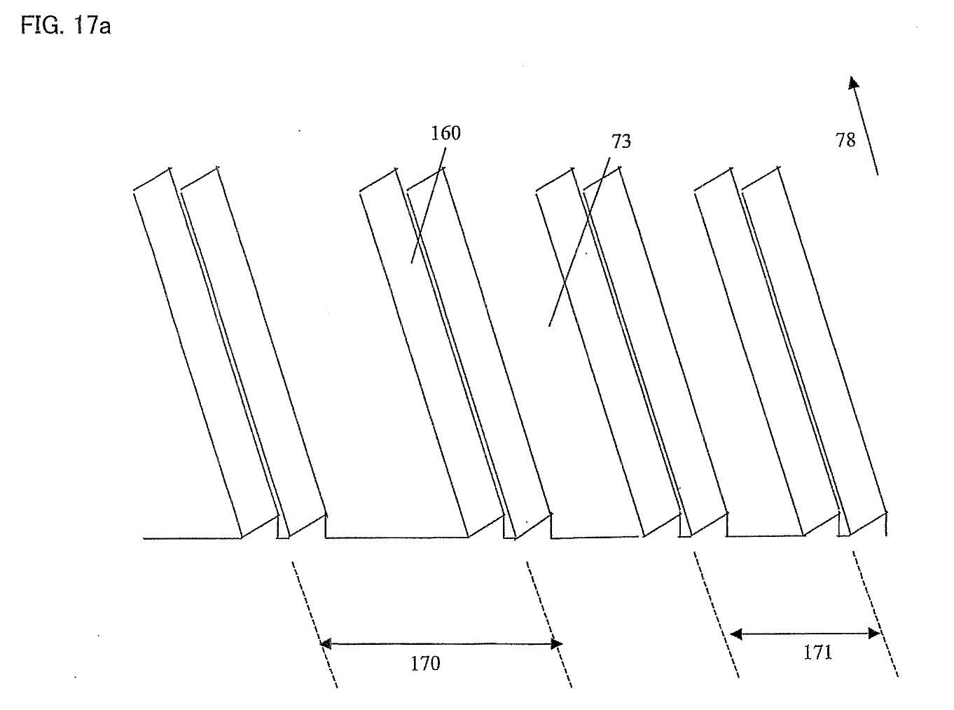

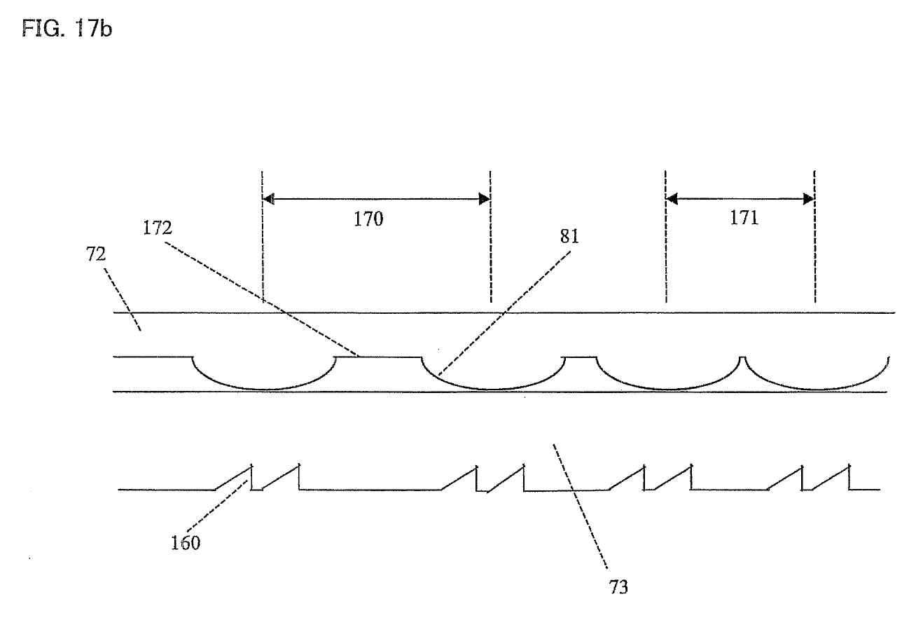

A third embodiment is shown in FIG. 17a and is similar to the first embodiment. Only the differences will be described here.

In this case, the extraction features are long prism structures, 160, that extend the whole length of the lightguide within one stripe. There may be more than one feature per stripe. These features still have an identical triangular cross section to the wedge features. The features are identical.

The spacing of the extraction feature stripes, however, is no longer constant and now varies to ensure uniformity (FIG. 17a). Triangular prism stripes are further apart near the light source, 170, than away from the light source, 171. The lens array, 72, has a corresponding difference in pitch, the lenses and stripe widths, 170 and 171, still remaining substantially identical (FIG. 17b), except for perhaps a viewpoint correction mentioned above. The lens power, 81, remains substantially the same as in the earlier embodiments. The varying pitch is made up from a series of flat gaps, 172, or extended lens sections.

Long prism type structures may be easier to manufacture than individual wedge type structures and this embodiment does not require split lines.

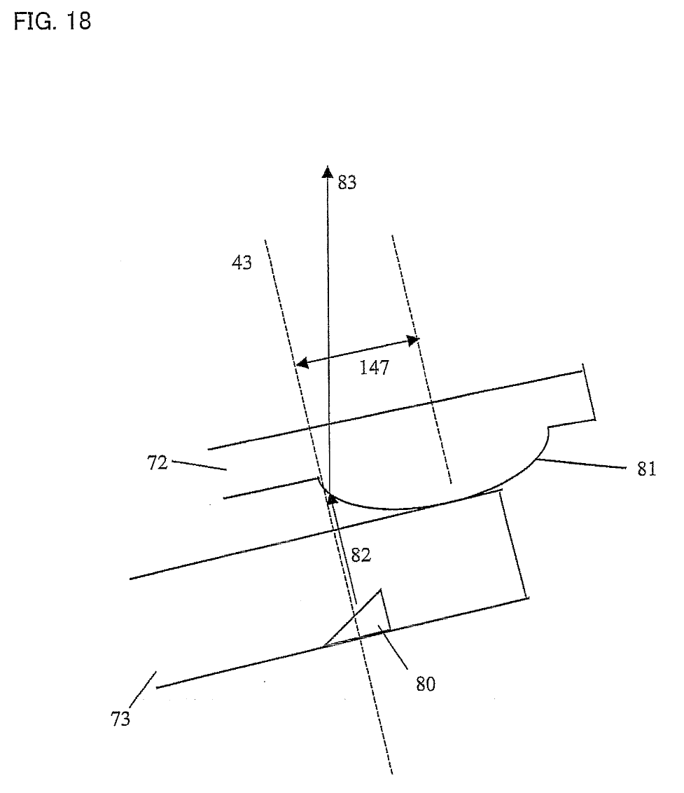

A fourth embodiment is shown in FIG. 18 and is similar to the first embodiment. Only the differences will be described here.

FIG. 18 illustrates that the size of the lens pitch is dependent primarily on the expected minimum bend radius and the thickness of the lightguide. The minimum semi-diameter, 147, of the lens is given by equation 3. The operation does not depend on the thickness of the lightguide but the size (and power) of the lens does.

In some circumstances (for example very low bend radii with thicker lightguides) the pitch required for the lens may be large enough to be visible though the diffusers and BEF structure.

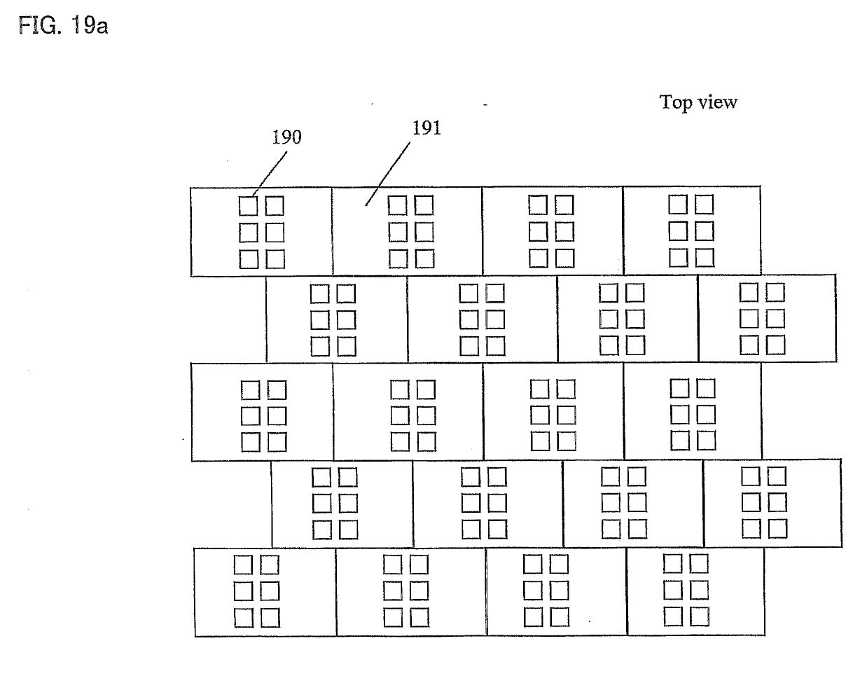

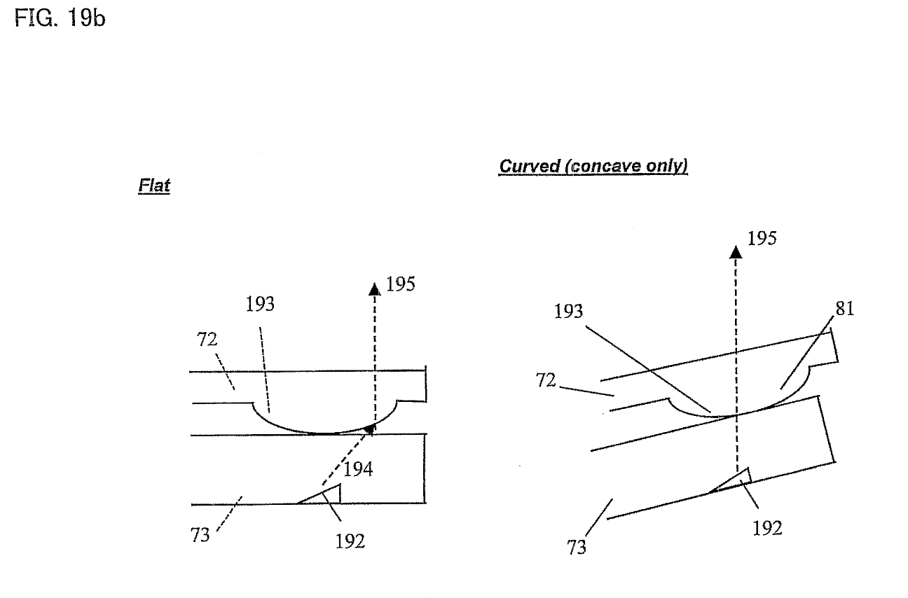

It is possible to reduce the visibility of these structures by separating the lenticular lenses into areas, 191, and staggering the lenses laterally perpendicular to the lenticular line. This can be done in a systematic or random fashion. FIG. 19a shows a top down view of lens sheet and extraction features from the lightguide. The extraction features can be grouped, 190, and arranged in a staggered fashion. There is also a corresponding adjustment in the lens sheet, 191.

This staggering should reduce the visibility of the structures and prevent Moiré effects.

It is also possible to reduce the lens pitch further if it is known in advance whether the bend will be convex or concave. FIG. 19b illustrates the design for a concave only design. In the flat backlight case, the extraction features, 192, direct light, 194 not along the local normal. The slope of the extraction features is less than previously away from the light sources, and greater than normal towards the light sources. This light meets the lens, 193, off-centre, and is directed towards the viewer by the lens, 195. When the backlight is bent, the light moves across the lens and is directed properly, 195, by the lens in the manner described above. For a give bend radius the pitch of the lens need only be half the pitch of the lens in the first embodiment. A similar argument applies for convex only, where the slope magnitudes are reversed relative to the light source direction.

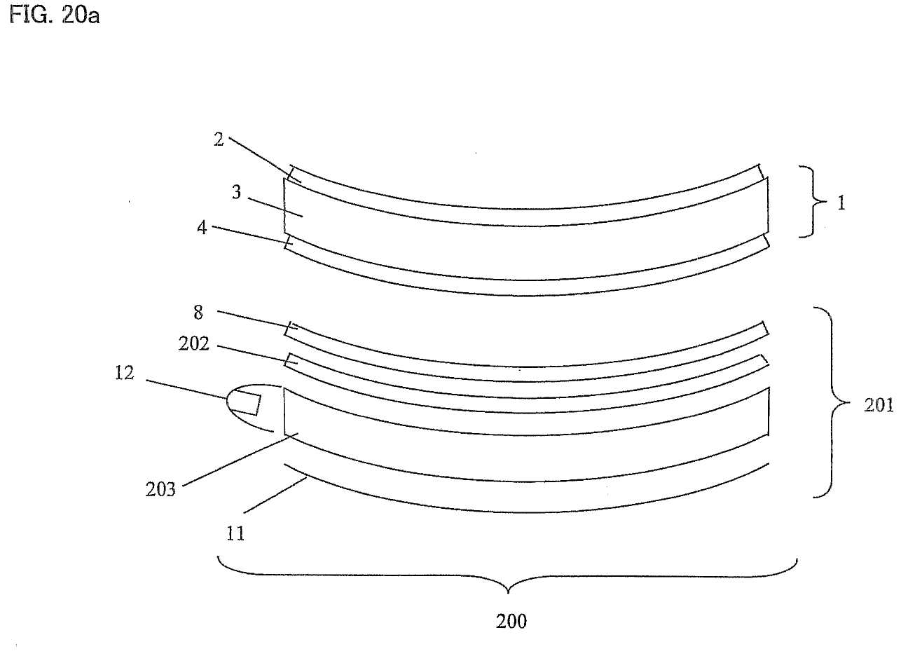

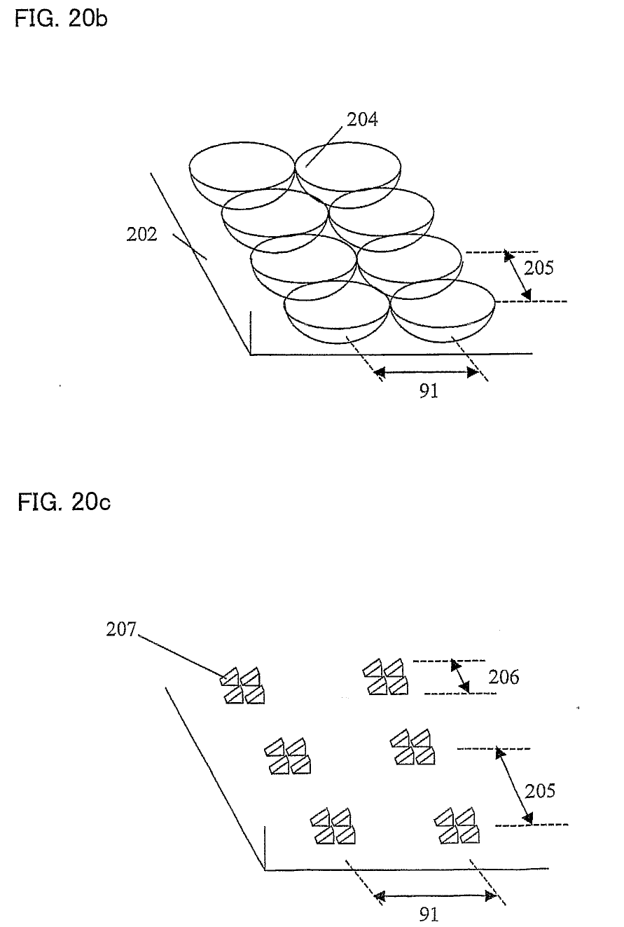

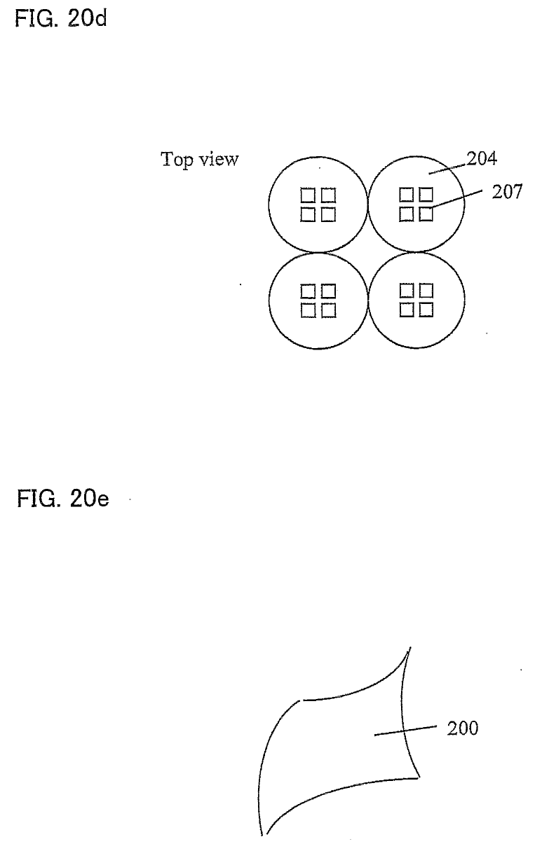

A fifth embodiment is shown in FIG. 20a and is similar to the first embodiment. Only the differences will be described here.

In this embodiment, display 200, illustrated in FIG. 20a, one of the diffusers, 5, and the other BEF, 6, are not required. The backlight part, 201, consists only of the light source, 12, reflector, 11, and lower diffuser, 8, that are unchanged from the first embodiment.

The backlight, 201, also consists of a lightguide, 203 and new lens array or sheet, 202, that are described below.

The lens sheet, 202, does not consist of long lenticular lens lines, but an array of identical circular (for example spherically converging) lenses, 204, in a uniform array (which could be square, triangular, hexagonal, random), the diameter of such lenses to be identical to the pitch of the original lenticular lens array, 91. These are illustrated in FIG. 20b.

The lightguide now has ‘islands’ of wedge shaped extraction features, 207, in the same pattern as the lens sheet array (FIG. 20c). There is a vertical pitch, 205, in which the wedge features occupy only a central area, 206, which could be half of the pitch. The position of the extraction features is aligned substantially with the centres of the lenses (FIG. 20d, view from top of backlight) or offset according to the direction of high brightness required.

The fixing of the lens sheet is now only in the exact centre of the display, 75, rather than along the centre line.

In this case, the bend angle can be in an arbitrary direction in a two dimensional plane, or involve multiple bends in multiple non-parallel directions and the performance would be the same as the corresponding flat backlight. The cross sectional diagrams in FIGS. 8 and 15 can now apply in an arbitrary direction (rather than just a fixed bend direction). One such bend is shown in FIG. 20e.

The application of this embodiment would be in fully flexible e-paper style applications with fully flexible displays.

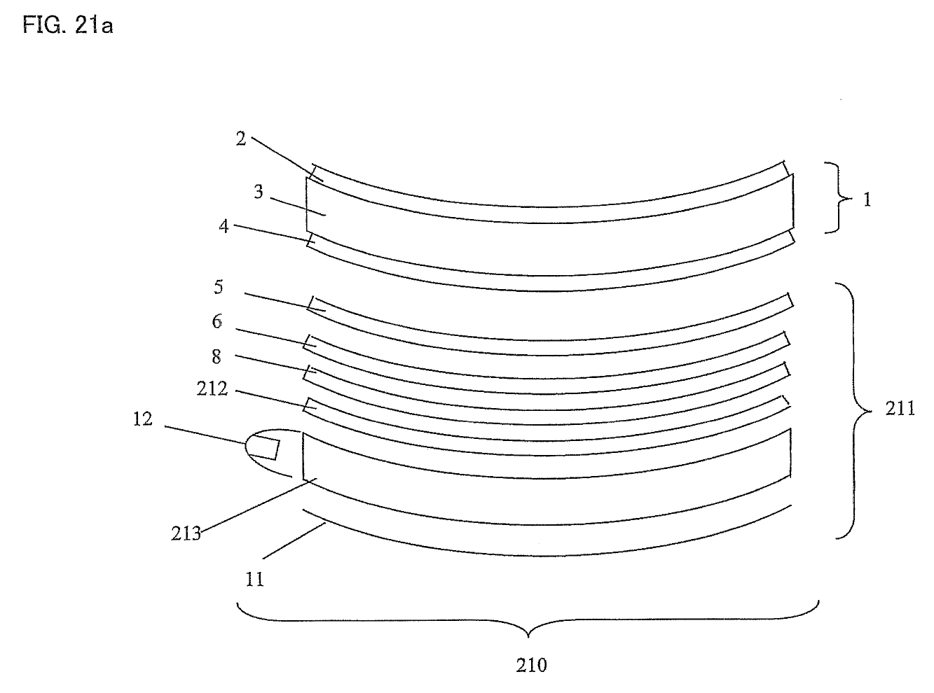

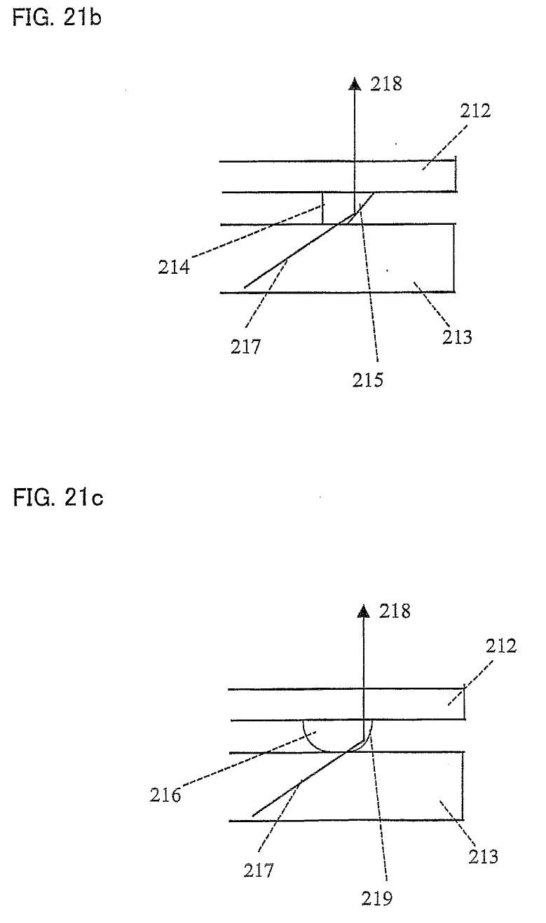

A sixth embodiment comprising a display 210 having a backlight 211 is shown in FIG. 21a and is similar to the first embodiment. Only the differences will be described here.

All other components remain the same, except the following features. The lightguide, 213, has no triangular shaped wedge extraction features. Also the lens sheet, 212, now has no lenses.

Instead, the top part of the lightguide, 213, has some features that are made from soft transparent deformable (for example resilient or flexible) material with a refractive index substantially similar to that of the lightguide and second layer, 212. Two possible forms for these features are shown in FIGS. 21b and 21c. Each of the features has a first surface attached to the second layer 212, a second surface attached to the lightguide 213, and a third surface which is inclined so as to reflect light, which has passed through the second surface, through the first surface.

The shape of these features can be a trapezoid, with a sloping side on the face away from the light source direction, illustrated in FIG. 21b. The sloping side, 215, is angled up and away from the lightguide, and in a direction away from the light sources. The wider top part of the trapezoid, 214, is fixed to the second layer, 212.

The shape of these features can also be a horizontal segment of a spheroid, 216, where the smaller cross section is fixed to the top surface of the first layer, 213, and the larger cross section is fixed to the second layer, 212. This is illustrated in FIG. 21c.

The flexibility of these features is substantially greater than the first, 213, and second layers, 212. In other words, the Young's modulus is substantially smaller for these features than that of the layers.

These individual features can be small distributed features or long prism-like structures similar to the extraction features described in the second to fourth embodiments.

No alignment is necessary in this embodiment.

In the case of the flat backlight, light, 217, is extracted from the lightguide through these features and is directed in a direction substantially along the local backlight normal, 218, by the sloping side of the trapezoid or the curved surface of the spheroid segments, 219.

The distribution of these features is not confined to stripes and is such that a uniform light emission is seen from the top surface of the backlight.

The slope of the trapezoid, 215, or the segment shape, 219, of the spheroid can be chosen so that the brightest direction to the viewer need not be along the central backlight normal.

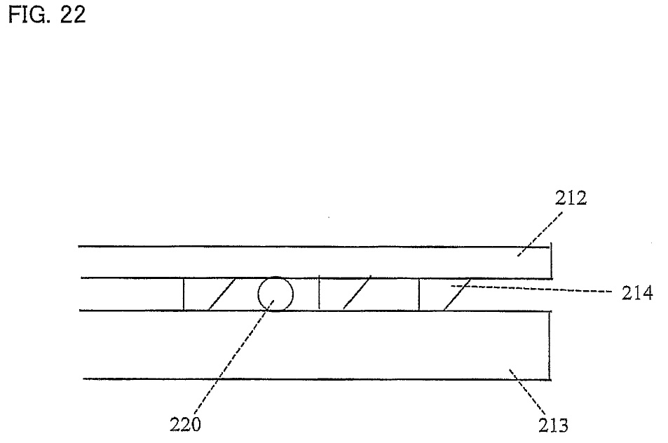

The separation of the first, 213, and second, 212, layers can be maintained by spacer balls, 220, of a known size between the extraction features. This is illustrated in FIG. 22.

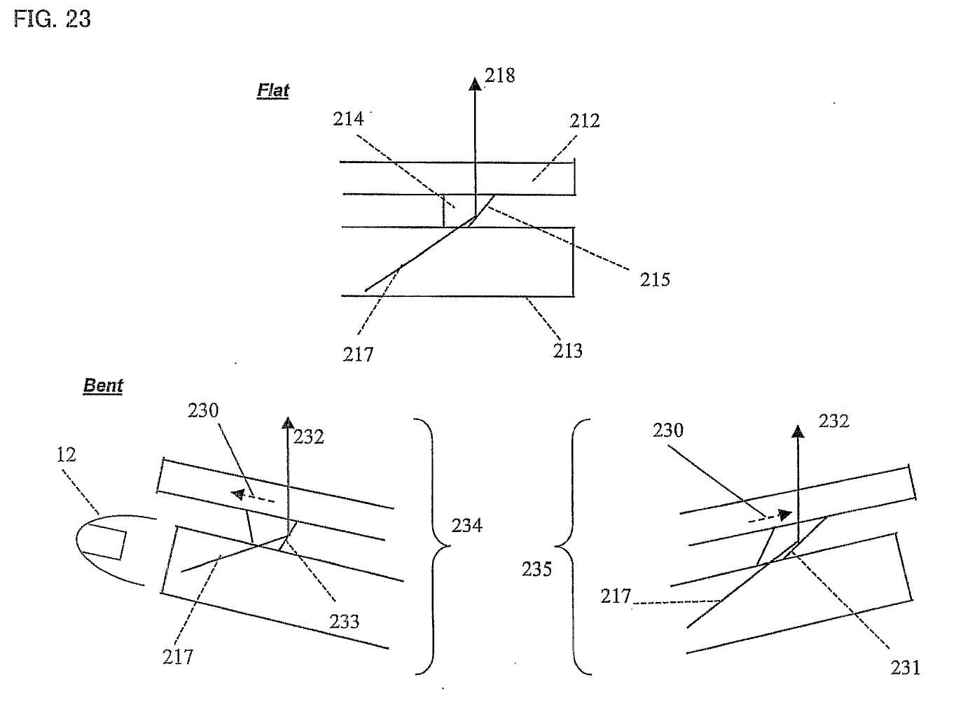

In operation, as illustrated in FIG. 23, when the display is curved, there is a parallax, as described above, between the first layer (lightguide), 213, and the second layer, 212. This causes the extraction features, 214, to deform in the direction indicated, 230.

The feature deforms in order to increase or decrease the slope angle, (of the trapezoid, for example), and this alters the direction, 232, that the light exits the second layer.

The change will mean that, on the side of the lightguide, 234, near the light source, 12, the slope angle for features, 233, will increase and on the side of the backlight, 235, far from the light source, the slope angle, 231, will decrease.

The change in slope angle of the trapezoid or spheroid causes light to exit the second layer in a direction, 232, still substantially parallel to the normal axis, 76, thus forming a corrected flexible display.

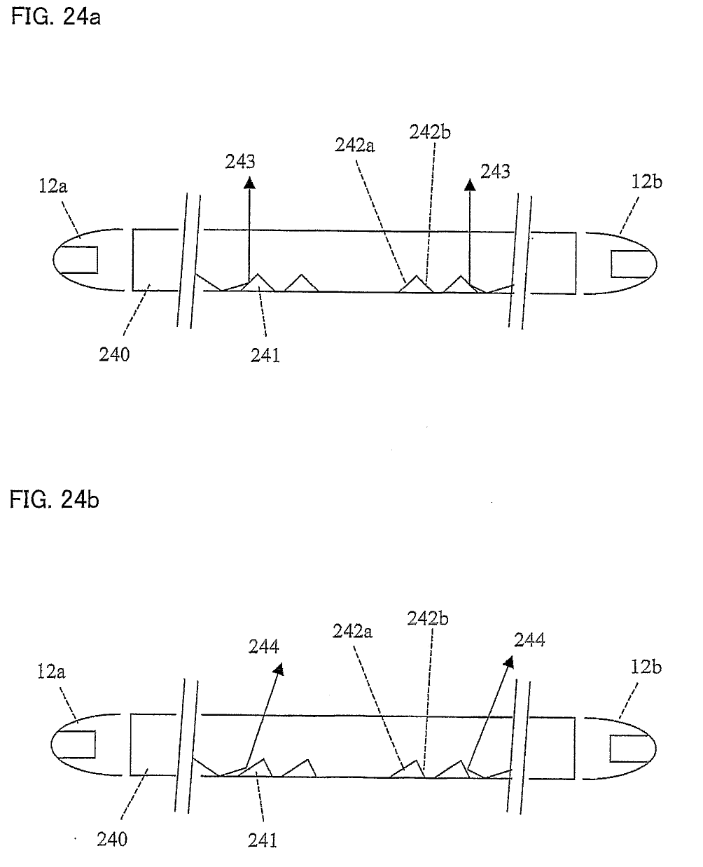

A seventh embodiment is shown in FIGS. 24a and 24b and can be applied to the first to fifth embodiments. Only the differences will be described here.

In this embodiment, light sources of the type above, 12a and 12b can be used on two opposing sides of the light guide, 240.

In this case, the triangular shaped wedge and prism structures for extraction from the light guide become symmetrical wedge and prism structures, 241, in that they have slope angles on two sides, 242a and 242b. This is illustrated in FIG. 24a. The lens sheet is not shown in this case. The two prism directions send light in a constant direction, 243, from the two light sources. The extraction features may still have the stripe and island appearance described above.

If the central brightness direction is along the normal axis at the centre of the display, 243, then the extraction features are symmetric at all points between the two directions to the light sources, i.e. 242a and 242b have an equal magnitude in their slopes.

If the emission direction 244 is not along the local normal axis (cf. Embodiment 4), then the slope angles may be different (FIG. 24b), i.e. 242a and 242b are different.

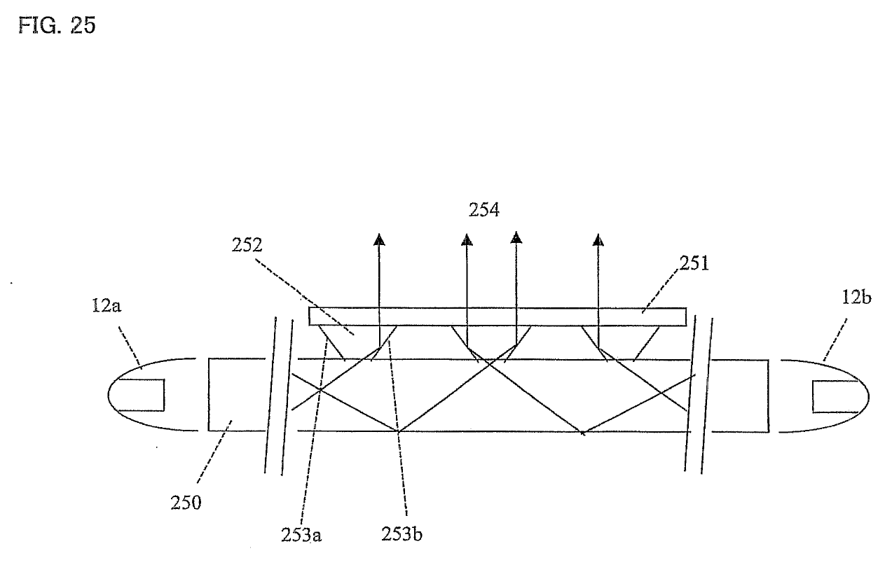

An eighth embodiment is shown in FIG. 25 and can be applied to the sixth embodiment. Only the differences will be described here.

In this embodiment, light sources of the type above can be used on more than one side (and can be all four sides) of the light guide.

FIG. 25 illustrates the case of two light sources, 12a and 12b, but can also be a cross section from a four light source system. The diagram illustrates the lightguide layer, 250, the second layer, 251, and the flexible extraction features 252.

Structures that use the trapezoid structure need a slope angle, 253, which may not be the same as the previous slope angle, in a direction away from the new light source(s). The two opposing slopes, 253a and 253b, then direct light from the two light sources in the proper direction, 254.

The operation of this embodiment following bending is identical to that of the sixth embodiment as illustrated in FIG. 23.

Structures that use the segmented spheroid structures need no further modification for this backlight to operate.

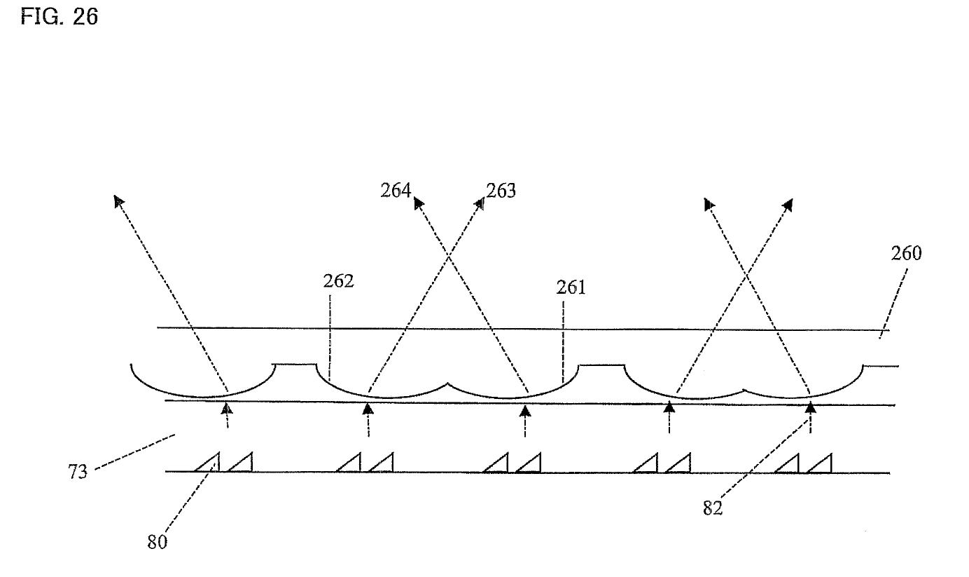

A ninth embodiment is shown in FIG. 26 and can be applied to all of the above embodiments. Only the differences will be described here.

In this embodiment it is possible to pattern, in a known or random way, different areas on the backlight that may be small. Each area consists of one of the embodiments above and is such that it directs light at a particular angle relative to the display normal. This angle may not be in a single plane.

The angles emitted from the areas may be in two (or more) separate directions, corresponding to viewers in two (or more) positions. The areas corresponding to one direction are distributed about the backlight surface so that the backlight appears uniform from that direction.

FIG. 26 shows a particular configuration of the embodiment where the changes from the first embodiment are only described here. In this case, it is only necessary to pattern the lens layer, 260, to create two or more offset lens positions, 262 and 261, between each stripe. The light, 82, extracted from the lightguide, 73, along the display local normal is then deviated in two separate directions, 263 and 264 by the lens segments.

The offset lenses can be staggered to reduce stripe visibility according to the fourth embodiment.

When the display is bent, the relative directions still remain fixed, bright and uniform, similar to the flat case.

The application of this embodiment is in displays where more than one off-axis direction is preferred such as a central display console in a car which needs to be bright towards driver and passengers.

This embodiment can also be applied to stereoscopic, autostereoscopic and other multiple view style displays.

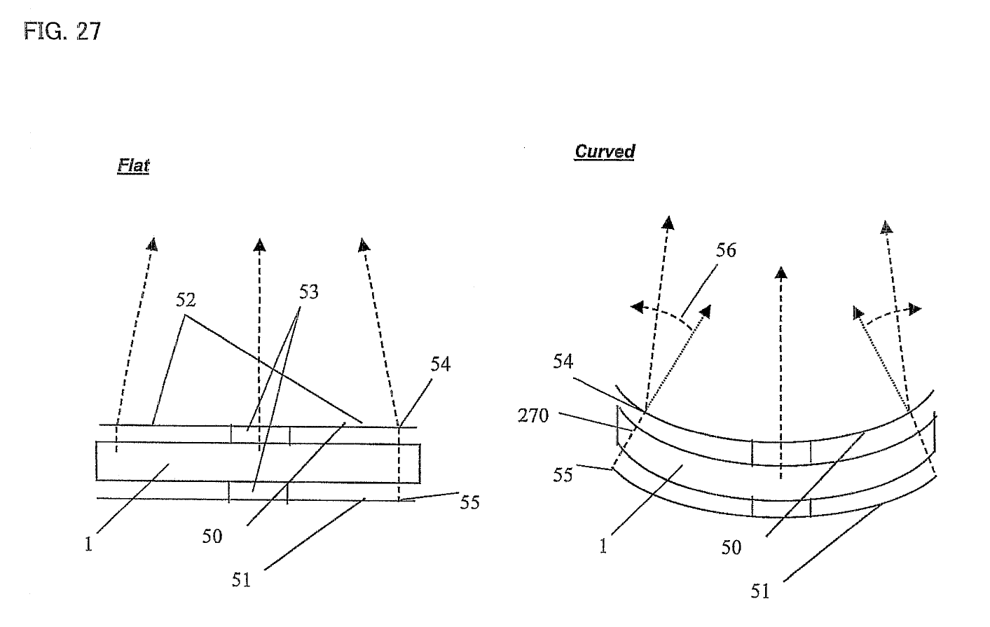

A tenth embodiment is shown in FIG. 27. Only the differences from the previous embodiments will be described here.

In this case, the first layer, 51, and the second layer, 50, of the backlight can lie either side of the display, 1. This is illustrated in FIG. 27.

The display itself may be the first layer or may incorporate the first layer.

In this case, the light, 270, from the first layer, 51, can be directed along the local normal, through the SLM display, 1, and is then directed to the viewer through the second layer, 50.

Displays typically have a contrast ratio and other quality metrics that vary with angle. In this case, the two layers interact to correct for the range of angles seen by the viewer on the display, as has been described above with reference to the backlight. Thus the range of angles seen at the display is reduced, and thus image quality is improved.

For example, the first layer may be the lightguide, 73, of the first embodiment and the second layer may be the lens array, 72, of the same embodiment.

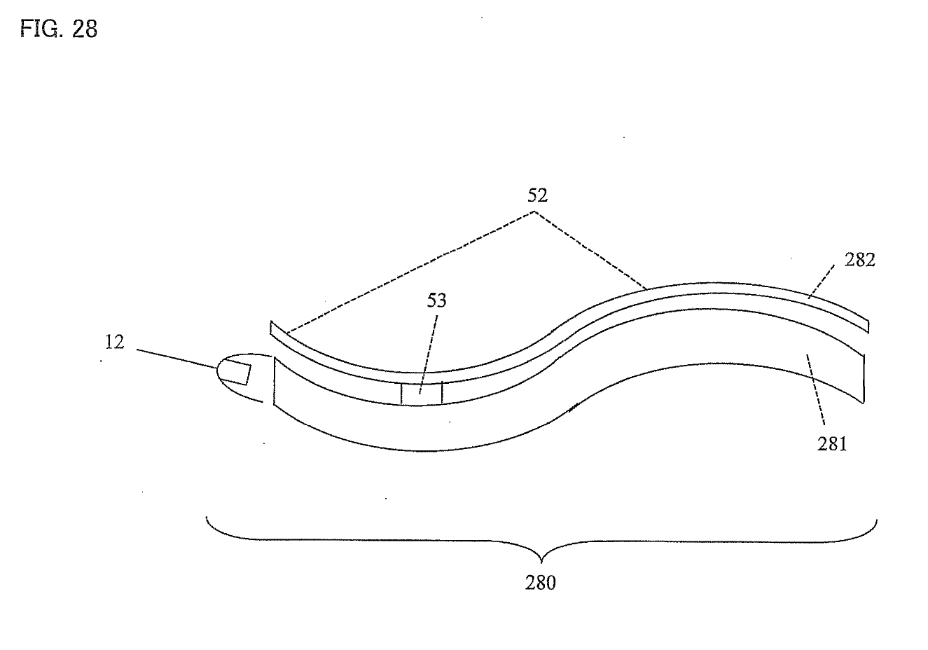

An eleventh embodiment is shown in FIG. 28 and can be applied to all of the above embodiments. Only the differences will be described here.

In this embodiment with display 280, the shape of the first layer, 281, and the second layer, 282, is not just circular but can be a complex shape involving both concave and convex sections.

The alignment at the fixing location, 53, defines the primary brightness direction.

The other embodiments above do not need to be modified to incorporate this embodiment.

Also, the embodiments may have facetted curve sections made up of straight sections at angles to each other.

The fifth embodiment can also have a complex curve in arbitrary direction in two dimensions.

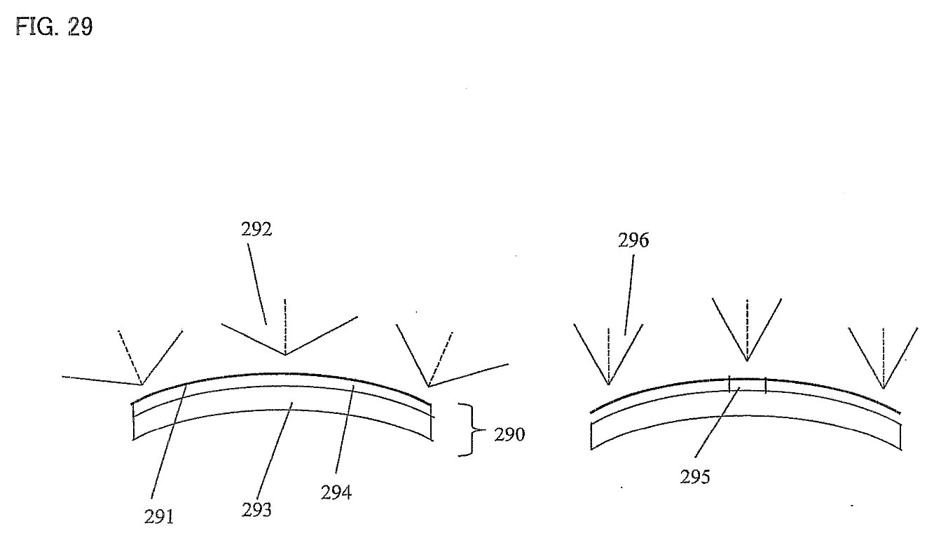

A twelfth embodiment shown in FIG. 29 can be applied to directional displays utilising parallax elements.

For example a multiple view, stereoscopic or autostereoscopic display, 290, that utilises a parallax optic 291 (such as a parallax barrier defining an array of apertures or lenticular lens sheet) can be made flexible, if the display and parallax optic are flexible and constrained to lie (freely) on top of each other.

A typical multiple view display, 290, comprises a display, 293, which displays a plurality of spatially multiplexed images, and a parallax optic, 291, which is glued to the display across its area, 294. When flat, the windows created by the display are parallel but, when the display is bent, the windows lose the parallel aspect, 292.

In this embodiment, the parallax optic, 291, is constrained to sit on the display, 293, during bending, but is free to move in at least one area and fixed in at least one area. In the case of a parallax barrier with apertures in the form of slits or lenticular lens sheet, 291, the barrier or sheet should be fixed in a line along the slits or lenticules in the centre of the display, 295, (for a 1D curve with a bend direction parallel to the slits or lenticules), or in the centre of the display for a 2D arbitrary curve.

When the display is bent, the additional parallax caused by the relative movement of the parallax optic and display is sufficient to keep the stereoscopic or multiple view window directions, 296, the same at all points on the display, keeping the same viewing freedom, uniformity, brightness and crosstalk conditions at any chosen bend condition.

The alignment at the fixing point determines the window direction.

This type of display can be a fully flexible system or a single design that can easily be adapted and fixed to many different styles, without redesign, and within a single manufacturing process. The curved displays are fixed in position according to the required style at the end of the manufacturing process.

Complex and facetted curves are also possible in this embodiment.

This display can be used with any of the flexible backlight embodiments described above.

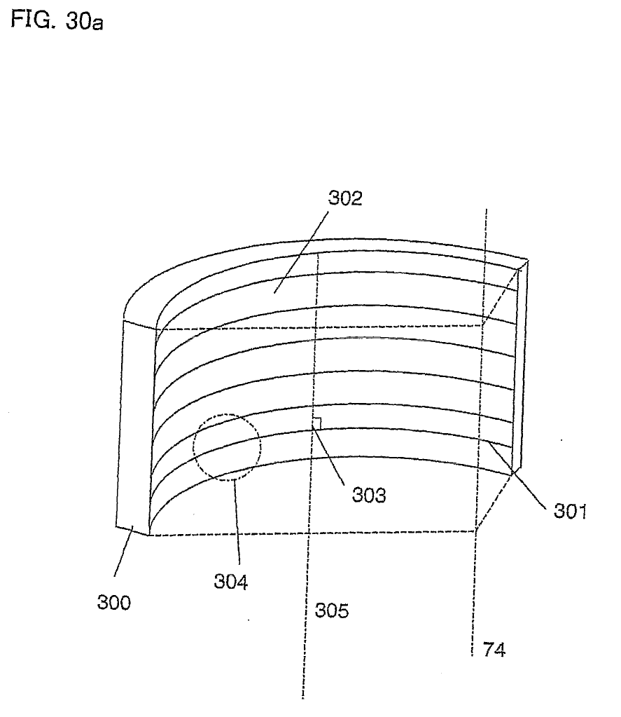

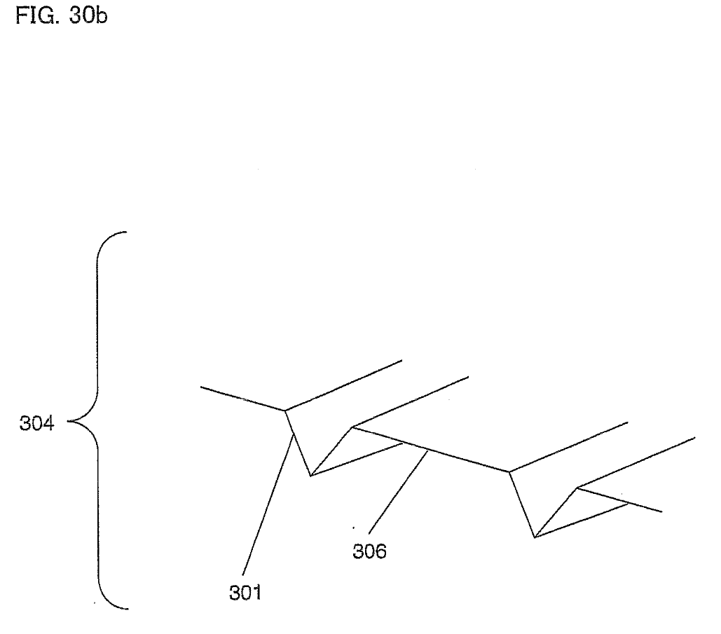

In the embodiment shown in FIG. 30a, the features of the embodiment shown in FIG. 7a are assumed, but this embodiment can be applied to any of the above embodiments, in particular those having one-dimensional curvature. This embodiment involves a modification to the lightguide 73, and will be described as such, but can also be applied in principle to the lens array 72 or other surfaces in the backlight 71.

The modified lightguide, 300, has a surface opposite that provided with the extraction features (for example the top surface), 302, provided with linear diffusion features, 301, which extend in a direction perpendicular to the cylindrical axis 74. The cylindrical axis 74 and a construction line, 305, in the plane of the surface 302, are parallel. The construction line 305 and the features 301 are perpendicular, 303, to each other. The scale of the diffusion features is greatly exaggerated and would normally be small enough not to be visible to the naked eye.

A detail, 304, of the diffusion features is shown to enlarged scale in FIG. 30b. The diffusion features 301 can have any cross-section, but the cross-section should not change substantially at any point along their lengths. A possibly optimum shape comprises a flat area, 306, of a certain width and a triangular groove cut into the lightguide. This cross-section is repeated across the lightguide.

These diffusion features act as a one-dimensional diffuser, diffusing only perpendicular to the curve direction, and act to reduce mixing region effects when the lightguide is used with point-like light sources, such as LEDs and/or lasers, rather than line sources, such as cold-cathode fluorescent tubes.

A further embodiment provides a modification to the lightguide and the other features of the display may remain the same. This embodiment may be applied to all of the embodiments described herein, in particular those having one-dimensional bend curvatures and point like light sources, such as LEDs and/or lasers 12a, 12b.

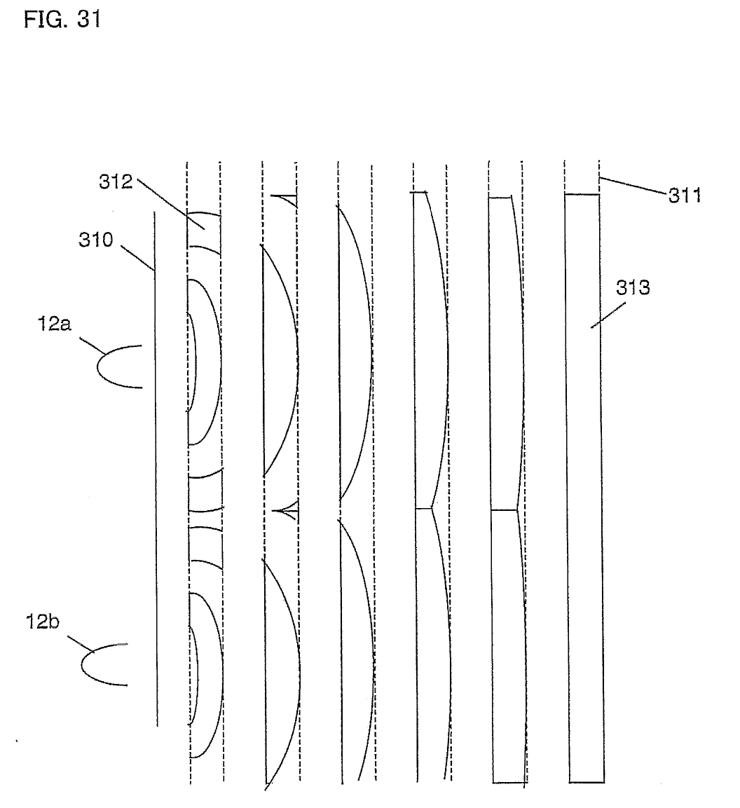

This embodiment is shown in plan view, and to an exaggerated scale, in FIG. 31 and comprises a lightguide, 310, for replacing the lightguide 73 in FIG. 7a, all other features remaining the same. The lightguide comprises curved wedge-type extraction features, 312, which are shown in unbroken lines and whose cross-section normal to the curve of the features is the same as previous embodiments.

Despite the curve, the extraction features, 312, are bounded by vertical broken lines or “construction lines”, such as 311, which are in the positions where the “straight” extraction features of FIG. 7a would have been. The curved extraction features may be modified by the application of staggered construction lines and variable size features for uniformity correction, as described hereinbefore. The features, such as that shown at 313, which are more remote from the light sources 12a, 12b may be unchanged as compared with the corresponding features of FIG. 7a.

This embodiment controls the angular direction of light from different places near the LEDs and further reduces the requirements on or for top diffusion. This is because the radiating light from the point sources will now be incident on the features at approximately the same angle substantially independent of feature location and so will be more uniform across the backlight.

In a further structure, the construction lines may follow the curves of the extraction features. In this case the lenses of the lens sheet must follow the same curved structure of the extraction features, and the curvature of the lenses in the direction perpendicular to the bend axis must still be constant to give the proper correction.

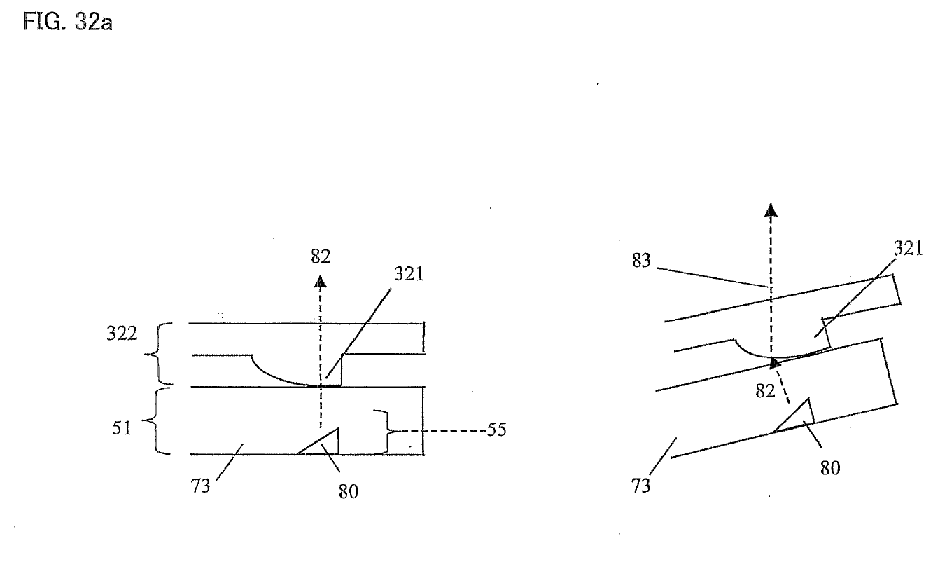

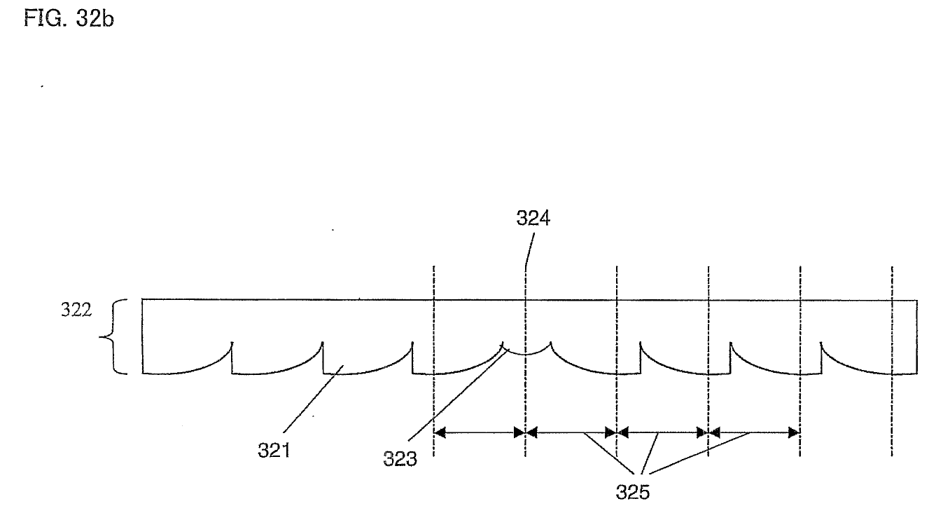

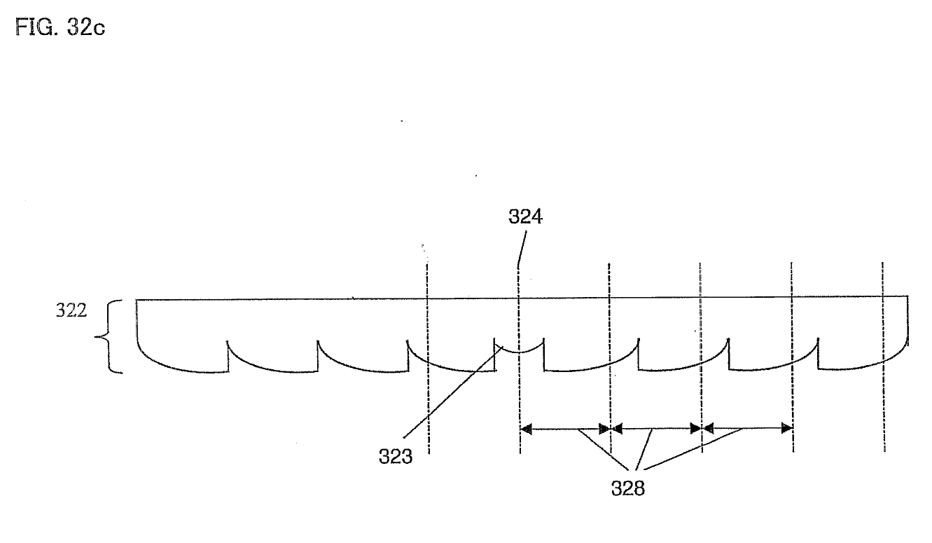

This further embodiment applies to the embodiment described hereinbefore for concave-only (or convex-only) lens sheets. The main structure of this embodiment is shown in FIG. 32a.

In this embodiment a modified lens array or sheet 322 replaces the lens sheet 72 of FIG. 7a. In this sheet, most of the lenses 321 are laterally asymmetric, anticipating that the non-fixed parts of the lens sheet will only move relative to the extraction feature lines in one direction during bending, as shown in the right-hand part of FIG. 32a. This has the advantage that significantly smaller lenses (of reduced width) are needed if only-convex or concave-only displays are required. Thus, the lens pitch may be greatly reduced so that the structure becomes less visible to a viewer without diffusion. Also, this allows a thicker lightguide for the same lens sheet/extraction feature pitch. This embodiment can equally apply to staggered embodiments and other embodiments described herein.

The asymmetric lenses can be the same at all points but, because the lenses are no longer symmetric, the complete lens sheet profile does alter about the central fixing point 324. The lens sheet is a mirror image about this point, and is shown in FIG. 32b for a concave-only curve and in FIG. 32c for a convex-only curve. The centre lens 323 at the fixing point will be smaller than the other lenses for this reason and is illustrated for this reason. The distance between the centres of all the lenses still follows the extraction feature pattern (for example constant pitch as shown at 325 and 328), including across the central fixing point area.

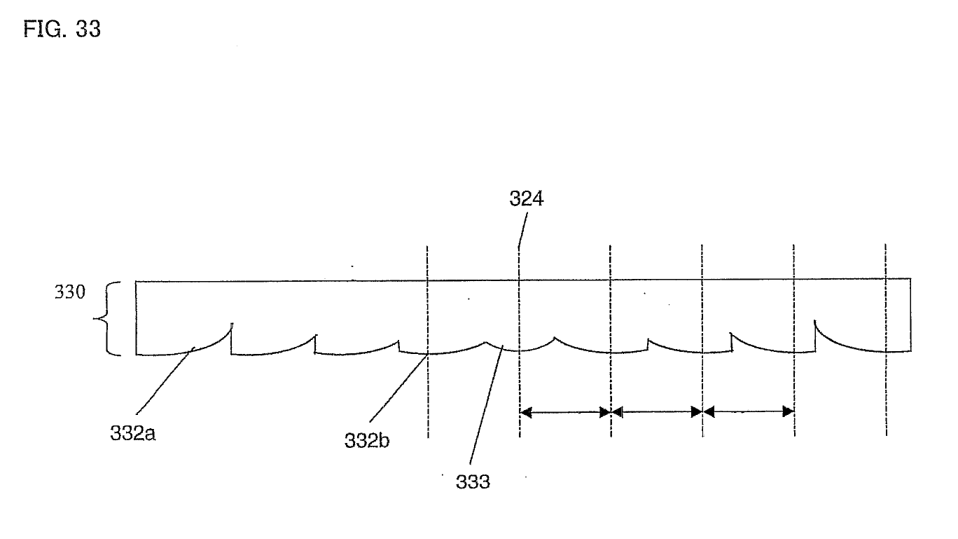

It is possible that the section “removed” from the lenses may vary across the lens sheet 330 and an example is shown in FIG. 33. The lens, 332a, is most asymmetric far from the fixing point, and the lens, 332b is more symmetric near the fixing point 324 whereas the lens at the fixing point, 333, is then similar to the lenses near it. This is in anticipation of the fact that, far from the fixing point, the movement on bending is greater than near the fixing point.

The ‘centres’ of each of the lenses, as above, however remain at constant pitch (or follow the extraction feature pattern in the lightguide) and are in the same relationship to the extraction features at all points in the flat backlight case.

An advantage of this embodiment is that the lenses are in a better format at the extraction features that are near the fixing point and reduce lost light on bending. Thus the variation will allow some optimisation to the brightness of the display.

This embodiment applies to all other embodiments including the Fresnel lens embodiments.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

1-37. (canceled)

38. A light output arrangement comprising a bendable light-outputting layer and a bendable light-directing layer constrained to bend in conformance with the light-outputting layer, a first point of the light-outputting layer and a first point of the light-directing layer being fixed relative to each other so as to prevent relative lateral movement between the first points, the light-directing layer comprising a plurality of structures arranged to direct light from the light-outputting layer passing through the light-directing layer in a substantially same direction relative to the first points irrespective of bending of the layers.

39. An arrangement as claimed in claim 38, in which the layers are constrained to have a substantially constant spacing irrespective of bending thereof.

40. An arrangement as claimed in claim 38 in which at least one second point of the light-outputting layer and at least one second point of the light-directing layer are fixed relative to each other, after bending of the layers, so as to prevent lateral movement between the layers.

41. An arrangement as claimed in claim 38, in which the first points are at or adjacent the middles of the layers.

42. An arrangement as claimed in claim 38, in which the light-outputting layer comprises a light guide.

43. An arrangement as claimed in claim 42, in which the light guide comprises a plurality of light extraction features.

44. An arrangement as claimed in claim 43, in which each light extraction feature is arranged to direct light out of the light guide in a direction substantially parallel to a local normal.

45. An arrangement as claimed in claim 43, in which each of the extraction features comprises a concave feature in a first surface of the light guide facing a second output surface of the light guide, and in which each of the concave features comprises at least one inclined surface for reflecting light travelling in the light guide towards the output surface.

46. An arrangement as claimed in claim 43, in which each of the structures cooperates with a set of the features for directing light in substantially the same direction, where each set comprises at least one feature.

47. An arrangement as claimed in claim 43, in which at least some of the extraction features are arcuate in plan.

48. An arrangement as claimed in claim 38, in which at least one of the surfaces of the light-outputting layer and the light-directing layer is provided with a plurality of linear light-diffusing features.

49. An arrangement as claimed in claim 38, in which the structures are arranged to direct light substantially parallel to the normal to the first point of the light-directing layer.

50. An arrangement as claimed claim 38, in which the structures are arranged to direct light in at least two different directions with respect to the normal to the first point of the light-directing layer.

51. An arrangement as claimed in claim 38, in which each of the structures comprises a lens.

52. An arrangement as claimed in claim 51, in which each lens is a converging lens.

53. An arrangement as claimed in claim 52, in which the lenses have a focal surface at the light-outputting layer.

54. An arrangement as claimed in claim 53 when dependent directly or indirectly on claim 6, in which the focal surface is at or adjacent the light extraction features.

55. An arrangement as claimed in claims 51, which each of at least some of the lenses is laterally asymmetrical so as to be of reduced width.

56. An arrangement as claimed in claim 52, in which the lenses are arranged as a one dimensional array of substantially cylindrically converging lenses.

57. An arrangement as claimed in claim 52, in which the lenses are arranged as a two dimensional array.

58. An arrangement as claimed in claim 57, in which the lenses are substantially spherically converging.

59. An arrangement as claimed in claim 55, in which the lenses are arranged as a one dimensional array of substantially cylindrically converging lenses.

60. An arrangement as claimed in claim 55, in which the lenses are arranged as a two dimensional array.

61. An arrangement as claimed in claim 60, in which the lenses are substantially spherically converging.

62. An arrangement as claimed in claim 38, comprising an at least partially transmissive spatial light modulator disposed between the light-outputting layer and the light-directing layer.

63. An arrangement as claimed in claim 38, in which the light-outputting layer is adjacent the light-directing layer.

64. An arrangement as claimed in claim 63 in which each structure comprises a deformable material having a first surface attached to a bendable sheet to form the light-directing layer, a facing second surface attached to the light-outputting layer and an inclined third surface for reflecting light, which has passed through the second surface of the material, through the first surface of the material.

65. An arrangement as claimed in claim 64, in which the material is resilient.

66. An arrangement as claimed in claim 64, which the material has a refractive index substantially equal to the refractive indices of the light-outputting layer and the sheet.

67. An arrangement as claimed in claim 64, in which each structure has a trapezoidal cross-section.

68. An arrangement as claimed in claim 64, in which each structure is part-spherical.

69. An arrangement as claimed in claim 38, comprising a backlight for an at least partially transmissive spatial light modulator.

70. A display comprising: an arrangement as claimed in claim 69 and an at least partially transmissive spatial light modulator.

71. A display comprising: an arrangement as claimed in claim 62 and an at least partially transmissive spatial light modulator.

72. A display as claimed in claim 71, in which the modulator comprises a liquid crystal device.

73. A display as claimed in claim 70, in which the modulator comprises a liquid crystal device.

74. A multiple view display comprising an arrangement as claimed in claim 38, in which the light-directing layer comprises a parallax optic, the structures comprise parallax elements and the light outputting layer comprises a display device for displaying a plurality of spatially multiplexed images.

75. A display as claimed in claim 74, in which the display device is a liquid crystal device.

76. A display as claimed in claim 74, in which the parallax optic comprises a lens sheet and the parallax elements comprise lenses.

77. A display as claimed in claim 74, in which the parallax optic comprises a parallax barrier and the parallax elements comprise apertures.

78. A display as claimed in claim 74, comprising a backlight for an at least partially transmissive spatial light modulator.

79. A display as claimed in claim 70, comprising a backlight for an at least partially transmissive spatial light modulator.
